(19) United States
(12) Patent Application Publication
(10) Pub. No.: US 2016/0125486 A1
(43) Pub. Date: May 5, 2016

(54) SETTLEMENT OPERATIONS SUPPORT SYSTEM AND SETTLEMENT OPERATIONS SUPPORT METHOD

(71) Applicants: Mitsuhiro KASAI, Tokyo (JP); Yuuji HIROSE, Tokyo (JP); Yusuke EBINE, Koto-ku, Tokyo (JP); Toshihisa KOYAMA, Tokyo (JP); Takahiro SUGIURA, Tokyo (JP)

(72) Inventors: Mitsuhiro KASAI, Tokyo (JP); Yuuji HIROSE, Tokyo (JP); Yusuke EBINE, Koto-ku, Tokyo (JP); Toshihisa KOYAMA, Tokyo (JP); Takahiro SUGIURA, Tokyo (JP)

(73) Assignee: Hitachi, Ltd.

(21) Appl. No.: 14/427,729

(22) PCT Filed: Sep. 12, 2012
(86) PCT No.: PCT/JP2012/073362

§ 371 Date: May 27, 2015

(51) Int. Cl. G06Q 30/04; G06Q 20/10

(52) U.S. Cl. CPC G06Q 30/04; G06Q 20/102

(57) ABSTRACT

To enable improvement of efficiency in various settlement operations and cost reduction by linking business-to-business transactions with bank transactions. A computer 100 configured to mediate e-commerce transactions between companies executes processing of receiving invoice data addressed to a buyer from a supplier terminal 200, storing the received invoice data in a storage device 101, and transmitting the invoice data to a buyer terminal 300 in response to an acquisition request from the buyer terminal 300. The buyer terminal 300 executes processing of receiving the invoice data from the computer 100, generating payment schedule data by attaching settlement information to the invoice data, and transmitting the generated payment schedule data to the computer 100. The computer 100 executes processing of specifying payment schedule data sharing a common predetermined item among the payment schedule data received from the buyer terminal 300, merging the payment schedule data by summing up payment amounts in the specified payment schedule data, and storing the merged payment schedule data as post-aggregation payment schedule data in the storage device 101.

### TECHNICAL FIELD

The present invention relates to a settlement operations support system and a settlement operations support method.

### BACKGROUND ART

With recent computerization of business-to-business transactions, there have been an increasing number of cases of electronic processing for receivables and payables. As a technology of surely managing correspondence relationships between credits and electronic receivables and thereby enabling efficient write-off management, for example, the following technology has been proposed.

Specifically, there has been proposed an accounts receivable write-off management system or the like, including: an electronic receivable management unit configured to receive accounts payable information from an accounts payable debtor terminal, to store the accounts payable information in a memory, and to register the accounts payable information in an electronic receivable register database by allocating a unique electronic receivable code to each piece of the accounts payable information in the memory; a settlement management unit configured to acquire, from a terminal of a financial institution, information of a credit given by the accounts payable debtor specifying the electronic receivable code, and storing the credit information in a credit database 6; a write-off management unit configured to execute write-off processing of reading the credit information stored in the credit database, searching the electronic receivable register database for electronic receivable information, and processing the record of the electronic receivable information found by the search processing by erasing the record from the electronic receivable register database or doing the like; and a write-off result notification unit configured to extract attribute information of the electronic receivables subjected to the write-off processing from the electronic receivable register database, and to notify the accounts payable debtor terminal and the like of the attribute information.

### CITATION LIST

### Patent Literature

### [PTL 1]

Japanese Patent Application Publication No. 2007-102457

### SUMMARY OF INVENTION

### Technical Problem

The computerization of business-to-business transactions has led to the emergence of services of a so-called B to B platform where information is shared among companies and business-to-business transactions are conducted on the Internet. Such a platform realizes cooperation between companies regarding various operations such as product design, sale, production, procurement and payment. Meanwhile, although receivables and payables between companies are fixed through transactions in the platform, settlement methods (e.g., remittance, account transfer, bill and check) are individually set between the companies, and are not standardized throughout the platform. Therefore, there is no significant linkage between business-to-business transactions on the platform and bank transactions associated with subsequent settlement.

For the above reason, a buyer, for example, needs to record contents of a number of paper invoices received from a supplier as invoice data, and to execute every accounts payable payment operation such as remittance. Thus, operational load and remittance/settlement costs tend to increase. Meanwhile, although the supplier can acquire, from the bank system, credit information that the buyer has paid accounts receivable, the credit information is not necessarily on an invoice-by-invoice basis. Therefore, considerable labor, time and sales management expenses are required to link (reconcile) the credit information with the accounts receivable.

Since there is no linkage between the business-to-business transactions and bank transactions, it is difficult to secure evidence that proves an actual breach of the compliance with the terms of payment agreed upon between companies, for example. Therefore, there is also a concern that frauds and clerical errors are left unaddressed. Such a concern is particularly strong in countries such as developing countries where fair business manners are yet to be established.

Therefore, it is an object of the present invention to provide a technology capable of improving the efficiency in various settlement operations and reducing costs thereof by linking business-to-business transactions with bank transactions.

### Solution to Problem

A settlement operations support method according to the present invention to solve the above problem includes the steps of: executing, by a computer configured to mediate e-commerce transactions between companies, processing of receiving invoice data addressed to a buyer from a terminal of a supplier in e-commerce, storing the received invoice data in a storage device, and, in response to an acquisition request from a terminal of the buyer, reading the invoice data from the storage device and transmitting the invoice data to the terminal of the buyer; executing, by the terminal of the buyer, processing of sending the computer a request to acquire the invoice data addressed to the buyer, receiving the relevant invoice data from the computer, generating payment schedule data addressed to the supplier by attaching predetermined settlement information or settlement information specified by the buyer through an input device to the invoice data, and transmitting the generated payment schedule data to the computer; and executing, by the computer, processing of specifying payment schedule data sharing a common predetermined item or predetermined item specified by the terminal of the buyer among the payment schedule data received from the terminal of the buyer, merging the payment schedule data by summing up payment amounts in the specified payment schedule data, and storing the merged payment schedule data as post-aggregation payment schedule data in the storage device.

A settlement operations support system according to the present invention includes: a computer configured to mediate e-commerce transactions between companies, the computer including an arithmetic device configured to execute processing of receiving invoice data addressed to a buyer from a terminal of a supplier in e-commerce, storing the received invoice data in a storage device, and, in response to an acquisition request from a terminal of the buyer, reading the invoice data from the storage device and transmitting the invoice data to the terminal of the buyer, processing of receiving payment schedule data addressed to the supplier, the payment schedule data being generated by the terminal of the buyer attaching predetermined settlement information or settlement information specified by the buyer through an input device to the invoice data, and processing of specifying payment schedule data sharing a common predetermined item or predetermined item specified by the terminal of the buyer among the received payment schedule data, merging the payment schedule data by summing up payment amounts in the specified payment schedule data, and storing the merged payment schedule data as post-aggregation payment schedule data in the storage device; the terminal of the buyer including an arithmetic device configured to execute processing of sending the computer a request to acquire the invoice data addressed to the buyer, receiving the relevant invoice data from the computer, generating payment schedule data addressed to the supplier by attaching predetermined settlement information or settlement information specified by the buyer through an input device to the invoice data, and transmitting the generated payment schedule data to the computer; and the terminal of the supplier including an arithmetic device configured to execute processing of transmitting the invoice data addressed to the buyer in e-commerce to the computer.

### Advantageous Effects of Invention

The present invention can improve the efficiency in various settlement operations and cost reduction by linking business-to-business transactions with bank transactions.

### BRIEF DESCRIPTION OF DRAWINGS

FIG. 1 is a diagram showing a network configuration example including a settlement operations support system according to an embodiment of the present invention.

FIG. 2 is a diagram showing a configuration example of a platform server according to the embodiment.

FIG. 3 is a diagram showing a configuration example of a supplier terminal according to the embodiment.

FIG. 4 is a diagram showing a configuration example of a buyer terminal according to the embodiment.

FIG. 5 is a data flowchart showing procedure example 1 of a settlement operations support method according to the embodiment.

FIG. 6 is a data flowchart showing procedure example 2 of the settlement operations support method according to the embodiment.

FIG. 7 is a data flowchart showing procedure example 3 of the settlement operations support method according to the embodiment.

FIG. 8 is a data flowchart showing procedure example 4 of the settlement operations support method according to the embodiment.

FIG. 9 is a data flowchart showing procedure example 5 of the settlement operations support method according to the embodiment.

FIG. 10 is a data flowchart showing procedure example 6 of the settlement operations support method according to the embodiment.

FIG. 11 is a diagram showing a specific example of change in payment schedule data before and after bilateral netting according to the embodiment.

FIG. 11A is a diagram showing a specific example of change in payment schedule data before and after multilateral netting according to the embodiment.

FIG. 11B is a diagram showing a specific example of relationship between receivables and payables before the multilateral netting according to the embodiment.

FIG. 11C is a diagram showing a specific example of relationship between receivables and payables after the multilateral netting according to the embodiment.

FIG. 12 is a diagram showing a specific example of invoice data according to the embodiment.

FIG. 12A is a diagram showing a specific example of payment schedule data according to the embodiment.

FIG. 13 is a diagram showing a specific example of post-aggregation payment schedule data according to the embodiment.

FIG. 13A is a diagram showing a specific example of buyer account information according to the embodiment.

FIG. 13B is a diagram showing a specific example of a status value list according to the embodiment.

FIG. 14 is a diagram showing a specific example of a payment advice according to the embodiment.

FIG. 14A is a diagram showing a specific example of accounts payable information according to the embodiment.

FIG. 15 is a diagram showing a specific example of credit schedule information according to the embodiment.

FIG. 15A is a diagram showing specific example 1 of accounts receivable information according to the embodiment.

FIG. 15B is a diagram showing a specific example of accounts receivable write-off schedule information according to the embodiment.

FIG. 16 is a diagram showing a specific example of credit information according to the embodiment.

FIG. 16A is a diagram showing specific example 2 of accounts receivable information according to the embodiment.

FIG. 16B is a diagram showing a specific example of credit overage and shortage information according to the embodiment.

FIG. 17 is a diagram showing output screen example 1 according to the embodiment.

FIG. 17A is a diagram showing output screen example 2 according to the embodiment.

FIG. 18 is a diagram showing output screen example 3 according to the embodiment.

FIG. 18A is a diagram showing output screen example 4 according to the embodiment.

FIG. 19 is a diagram showing output screen example 5 according to the embodiment.

FIG. 19A is a diagram showing output screen example 6 according to the embodiment.

### DESCRIPTION OF EMBODIMENTS

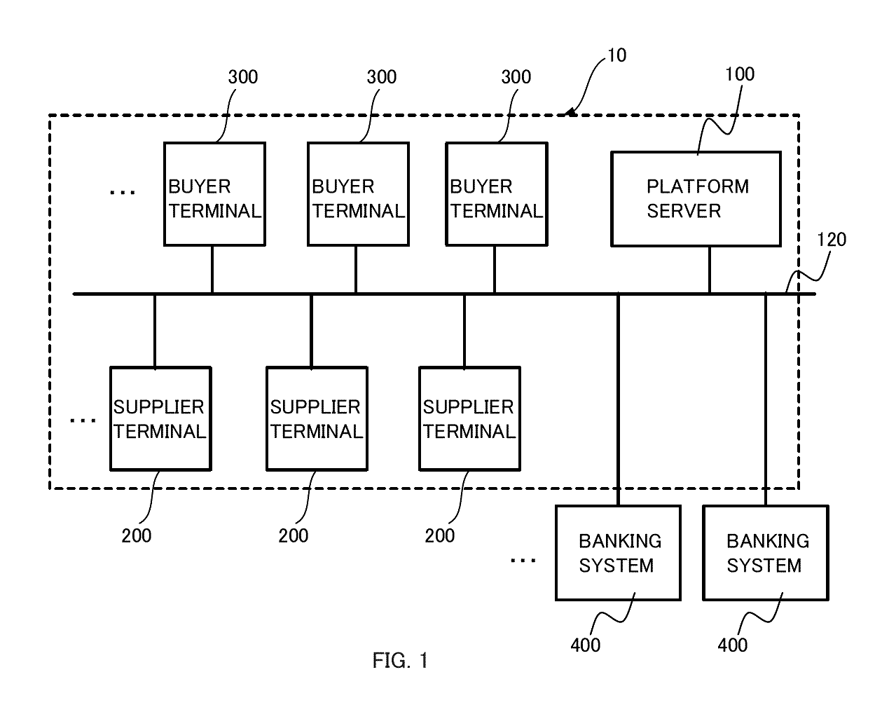

With reference to the drawings, an embodiment of the present invention is described in detail below. FIG. 1 is a diagram showing a network configuration example including a settlement operations support system according to an embodiment of the present invention. A settlement operations support system 10 shown in FIG. 1 is a computer system capable of improving the efficiency in various settlement operations and reducing costs thereof by linking business-to-business transactions with bank transactions. The settlement operations support system 10 includes: a platform server 100 that is a computer to mediate e-commerce transactions between companies, and provides a B to B platform; and supplier terminals 200 and buyer terminals 300 using a platform service by accessing the platform server 100. The platform server 100, the supplier terminals 200 and the buyer terminals 300 are linked to each other through a network 120.

Note that each of the supplier terminals 200 described above is a terminal used by a supplier company that sells products to other companies in e-commerce. Each of the buyer terminals 300 is a terminal used by a buyer company that purchases products from other companies in e-commerce.

A banking system 400 used for settlement in e-commerce is also coupled to the network 120 described above. The platform server 100, the supplier terminals 200 and the buyer terminals 300 can each access the banking system 400 of a bank, with which an account thereof has been opened, through authentication and the like via the network 120 and request necessary information and processing.

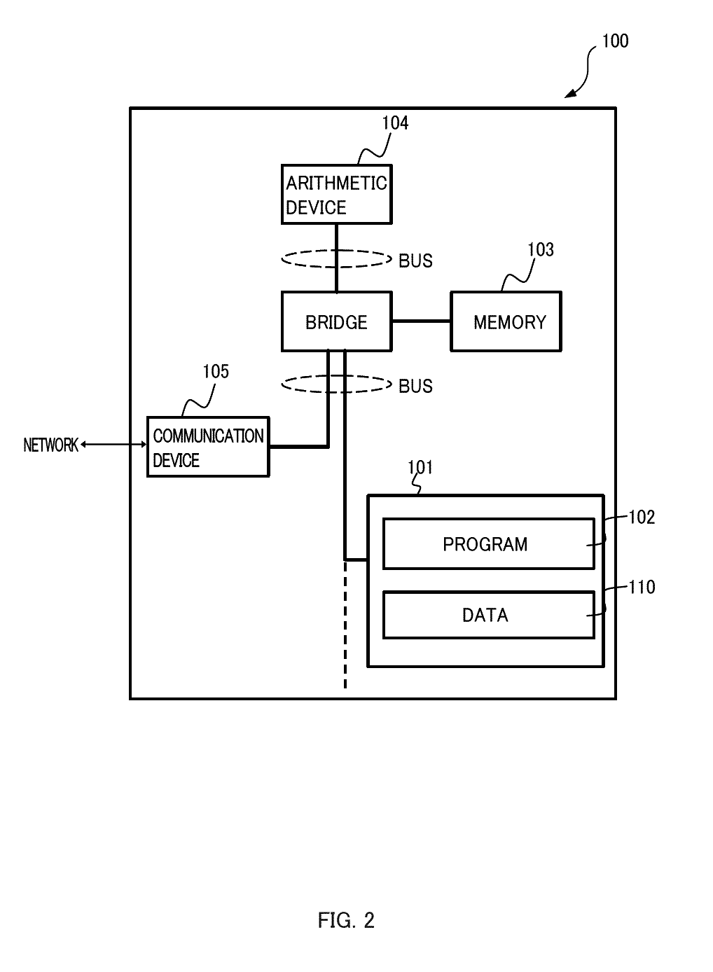

Moreover, each of the information processors included in the settlement operations support system 10 has the following hardware configuration. FIG. 2 is a diagram showing a configuration example of the platform server 100 according to this embodiment. The platform server 100 that is the computer included in the settlement operations support system 10 includes: a storage device 101 configured using an appropriate nonvolatile storage such as a hard disk drive; a memory 103 configured using a volatile storage such as a RAM; an arithmetic device 104 such as a CPU configured to perform overall control of the platform server itself by reading a program 102 stored in the storage device 101 onto the memory 103 and executing the program, and to perform various determination, arithmetic and control processing; and a communication device 105 coupled to the network and configured to perform communication processing with the other devices. Note that the storage device 101 stores: the program 102 to implement functions required for the information processor included in the settlement operations support system 10 according to this embodiment; and data 110 required for various processing. The data 110 includes invoice data 125 to be described later and various data generated from the invoice data 125 and other information. The same goes for the supplier terminal 200 and the buyer terminal 300.

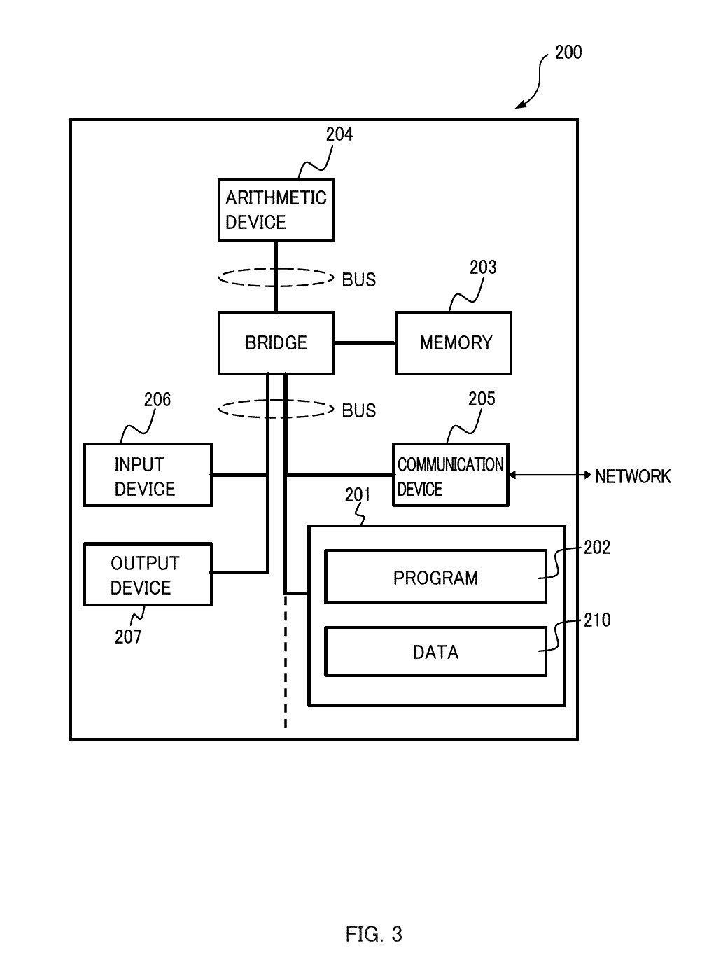

Note that, as shown in FIG. 3, the supplier terminal 200 described above includes a general hardware configuration of a computer. As in the case of the platform server 100, the supplier terminal 200 includes: a storage device 201 configured using an appropriate nonvolatile storage such as a hard disk drive; a memory 203 configured using a volatile storage such as a RAM; an arithmetic device 204 such as a CPU configured to perform overall control of the supplier terminal itself by reading a program 202 stored in the storage device 201 onto the memory 203 and executing the program, and to perform various determination, arithmetic and control processing; a communication device 205 coupled to the network and configured to perform communication processing with the other devices; an input device 206 such as a keyboard and a mouse to receive an input from a person in charge of a supplier company that is a user; and an output device 207 such as a display and a speaker to output processing results. The storage device 201 stores: the program 202 to implement functions required for the information processor included in the settlement operations support system 10 according to this embodiment; and data 210 required for various processing.

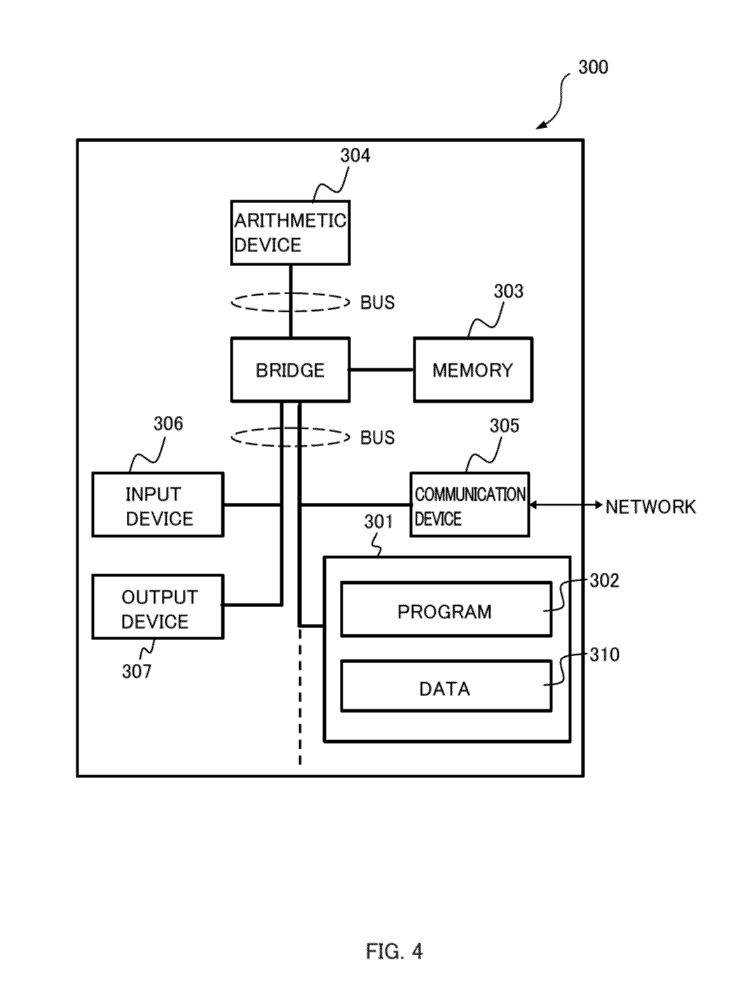

Meanwhile, as shown in FIG. 4, the buyer terminal 300 also includes the same hardware configuration as that of the supplier terminal 200 described above. The buyer terminal 300 includes: a storage device 301 configured using an appropriate nonvolatile storage such as a hard disk drive; a memory 303 configured using a volatile storage such as a RAM; an arithmetic device 304 such as a CPU configured to perform overall control of the buyer terminal itself by reading a program 302 stored in the storage device 301 onto the memory 303 and executing the program, and to perform various determination, arithmetic and control processing; a communication device 305 coupled to the network and configured to perform communication processing with the other devices; an input device 306 such as a keyboard and a mouse to receive an input from a person in charge of a supplier company that is a user; and an output device 307 such as a display and a speaker to output processing results. The storage device 301 stores: the program 302 to implement functions required for the information processor included in the settlement operations support system 10 according to this embodiment; and data 310 required for various processing.

Next, description is given of functions of the information processors, i.e., the platform server 100, the supplier terminal 200 and the buyer terminal 300, which are included in the settlement operations support system 10 according to this embodiment. As described above, it can be said that the functions described below are those implemented by executing the programs included in the platform server 100, the supplier terminal 200 and the buyer terminal 300, which are included in the settlement operations support system 10, for example.

The platform server 100 has functions to receive invoice data addressed to a buyer from a terminal of a supplier in e-commerce, i.e., the supplier terminal 200, to store the received invoice data in the storage device 101, and, in response to an acquisition request from a terminal of the buyer, i.e., the buyer terminal 300, to read the invoice data from the storage device 101 and transmit the invoice data to the buyer terminal 300.

On the other hand, the buyer terminal 300 has functions to send a request to acquire the invoice data addressed to the buyer to the platform server 100, to receive the relevant invoice data from the platform server 100, to generate payment schedule data addressed to the supplier by attaching predetermined settlement information or settlement information specified by the buyer through the input device 301 to the invoice data, and to transmit the generated payment schedule data to the platform server 100.

Meanwhile, the platform server 100 has functions to specify payment schedule data sharing a common predetermined item or predetermined item specified by the buyer terminal 300 among the payment schedule data received from the buyer terminal 300 described above, to merge the payment schedule data by summing up payment amounts in the specified payment schedule data, and to store the merged payment schedule data as post-aggregation payment schedule data in the storage device 101.

The settlement operations support system 10 having such functions automatically generates payment schedule data of use to the buyer, based on the invoice data (electronic data) obtained from the supplier side, and further aggregates data by merging data on payment schedules with payment amounts that can be summed up because of the same bank account to which money is to be deposited, thereby enabling reduction in the number of actual settlement transactions (transfer transaction to a bank account designated by the supplier) to be subsequently performed. Thus, the number of settlement transactions can be reduced to improve processing efficiency and reduce not only time and effort to perform such operations but also settlement cost.

Note that the buyer terminal 300 described above has a function to display the invoice data received from the platform server 100 on the output device 307.

Moreover, the buyer terminal 300 has a function to receive, with the input device 306, a result of matching by the buyer between a content indicated by the invoice data displayed on the output device 307 and a content indicated by a paper invoice sent from the supplier to the buyer.

In this case, when the result received through the input device 306 indicates that there is no difference between the content of the invoice data and the content of the paper invoice, the buyer terminal 300 has functions to generate accounts payable information based on the invoice data described above and to transmit the accounts payable information to the platform server 100. On the other hand, when the result received through the input device 306 indicates that there is a difference between the content of the invoice data and the content of the paper invoice, the buyer terminal 300 has a function to transmit the difference information to the platform server 100.

As described above, by reflecting the matching result between the actual paper invoice and invoice data (electronic data) on subsequent processing, good data quality of the invoice data and good accuracy of the subsequent processing using the invoice data can be maintained.

Meanwhile, the platform server 100 has functions to receive the difference information described above from the buyer terminal 300, to store the difference information in the storage device 101, and to transmit an acknowledgment request about the difference described above to the supplier terminal 200. Note that examples of the paper invoice described above include a fapiao used in China. The fapiao is an invoice or receipt in China, and a legal fapiao form issued by a tax agency is used.

Moreover, the platform server 100 has functions to read post-aggregation payment schedule data about the buyer from the storage device 101 upon receipt of a payment request from the buyer terminal 300, and to transmit a request for a settlement transaction corresponding to a content indicated by the post-aggregation payment schedule data to the banking system 400 of a bank used by the buyer, which is indicated by the post-aggregation payment schedule data.

Furthermore, the platform server 100 has functions to generate a payment advice about the invoice data, for which a settlement transaction has been requested by the processing of transmitting the request for the settlement transaction to the banking system 400 of the bank used by the buyer, and to transmit the payment advice to the supplier terminal 200.

The settlement operations support system 10 including such functions can transmit a settlement transaction request based on pre-aggregated payment schedule data to the banking system 400, thereby enabling reduction in the number of transfers and reduction in transfer cost associated therewith. Moreover, the payment advice described above allows the supplier to know, before notification from the banking system 400, that the payment has been done by the buyer. There is also an effect to achieve cooperation between the platform server 100 in the settlement operations support system 10 and the banking system 400.

Furthermore, the buyer terminal 300 has functions to, along with the payment request to the platform server 100, acquire the post-aggregation payment schedule data from the platform server 100, and to display the post-aggregation payment schedule data on the output device 307. In this case, the buyer terminal 300 has a function to receive, through the input device 306, a result of determination of whether or not a payment request can be made, by the buyer checking a content indicated by the post-aggregation payment schedule data against a content indicated by a paper invoice sent from the supplier to the buyer.

Moreover, in this case, when the above result received through the input device 306 approves the payment request, the buyer terminal 300 has a function to transmit the payment request to the platform server 100. On the other hand, when the above result received through the input device 306 rejects the payment request, the buyer terminal 300 has a function to transmit the rejection to a predetermined terminal such as a predetermined supervisor terminal in the buyer company without transmitting the payment request to the platform server 100.

Such functions included in the settlement operations support system 10 can maintain good accuracy of the payment request and good accuracy of subsequent processing by reflecting the matching result between the paper invoice and the post-aggregation payment schedule data on the subsequent processing.

Moreover, the platform server 100 has functions to receive accounts payable information based on the invoice data from the buyer terminal 300 and to store the accounts payable information in the storage device 101. In this case, the platform server 100 has functions to specify, using the storage device 101, accounts payable information corresponding to invoice data identification information included in the settlement transaction request described above according to the processing of transmitting the settlement transaction request to the banking system 400 of the bank used by the buyer, and to execute write-off processing for the accounts payable information. Such functions included in the settlement operations support system 10 can improve operational efficiency by automatically executing the write-off processing for the accounts payable.

Furthermore, the platform server 100 has functions to generate credit schedule information to the account of the supplier at a bank used by the supplier from payment detail information to the supplier, which is included in the settlement transaction request or payment advice, according to the generation of the payment advice described above or an instruction of the supplier terminal 200, and to store the credit schedule information in the storage device 101.

In this case, the platform server 100 has functions to receive accounts receivable information based on invoice data from the supplier terminal 200, and to store the accounts receivable information in the storage device 101. The platform server 100 also has functions to specify, using the storage device 101, accounts receivable information corresponding to the invoice data identification information, which is included in the credit schedule information described above, by matching the credit schedule information and the accounts receivable information, and to generate write-off schedule information on the accounts receivable.

Such functions included in the settlement operations support system 10 can automatically generate the accounts receivable write-off schedule information, and thus improve the efficiency of accounts receivable write-off processing when actual credit is confirmed later.

Moreover, the platform server 100 has functions to receive notification, from the banking system 400 of the bank used by the supplier, to the effect of the credit to the account of the supplier described above, to specify accounts receivable write-off schedule information corresponding to credit details indicated by the notification by matching the credit details and the accounts receivable write-off schedule information described above, and to determine overage and shortage of a credit amount for the specified accounts receivable.

In this case, when there is no overage or shortage of the credit amount as a result of the determination described above, the platform server 100 has a function to execute write-off processing of the specified accounts receivable. On the other hand, when there is overage or shortage of the credit amount as a result of the determination described above, the platform server 100 has a function to transmit overage or shortage amount information to the supplier terminal 200 and the buyer terminal 300. Note that the accounts receivable write-off processing may be performed even when there is credit overage or shortage. In this case, if the credit is short, write-off for the credit is performed. Alternatively, transmission of overage or shortage amount information and the write-off may be both performed.

Such functions included in the settlement operations support system 10 can realize an efficient accounts receivable write-off operation while achieving cooperation between the platform server 100 in the settlement operations support system 10 and the banking system 400. Moreover, such functions can cope with a situation where there is overage or shortage of credit amount from the buyer.

As a reason for such overage or shortage of credit amount, a situation is assumed where only a part of the payment is made in breach of compliance with the terms of payment agreed upon between the supplier and the buyer, for example. Even in such a situation, the settlement operations support system 10 according to this embodiment can specify invoice data or accounts receivable information with overage or shortage of credit amount and can track the details thereof. Thus, as a matter of course, labor for clerical work can be saved, such as confirmation of evidence upon occurrence of overage or shortage of credit amount, and errors and fraud in paperwork can be prevented.

The platform server 100 also has functions to read the post-aggregation payment schedule data described above for a pair of supplier and buyer or more, respectively, to offset the payment amount between the supplier and the buyer, and to transmit a settlement transaction request corresponding to a content indicated by the post-aggregation payment schedule data for remaining payables after the offsetting to the banking system 400 of the bank used by the supplier or the buyer, which is indicated by the payment schedule data including only the content for the remaining payables.

Such functions included in the settlement operations support system 10 can offset money transfer transactions associated with receivables (accounts receivable) and payables (accounts payable) held by participants in e-commerce, thereby enabling settlement for only a difference on a certain due date, for example.

With reference to the drawings, description is given below of actual procedures of a settlement operations support method according to this embodiment. Various operations corresponding to the settlement operations support method described below are realized by the programs read onto the memories or the like and executed by the platform server 100, the supplier terminal 200 and the buyer terminal 300 described above, which are included in the settlement operations support system 10. Also, some of the processing includes interactions between the settlement operations support system 10 and the banking system 400. The programs include codes for performing the various operations described below.

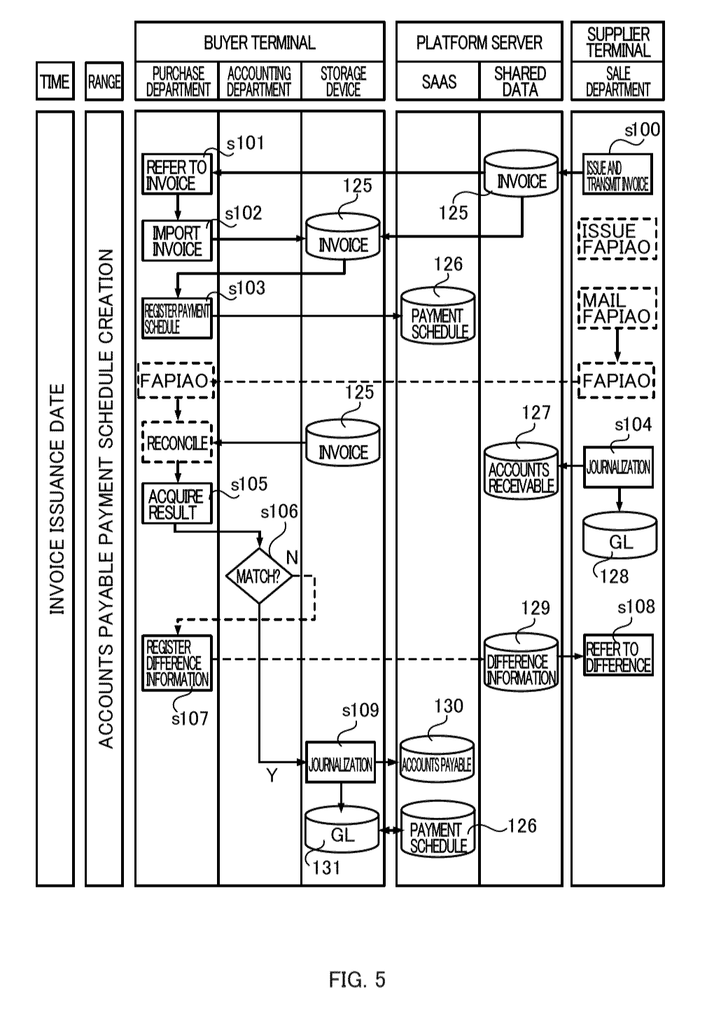

FIG. 5 is a data flowchart showing procedure example 1 of the settlement operations support method according to this embodiment. Here, first, the supplier terminal 200 transmits invoice data that is invoice data inputted by a person in charge of a sales division in a supplier company to the platform server 100 (s100). In this event, the platform server 100 receives invoice data 125 transmitted from the supplier terminal 200, and stores the invoice data 125 in a shared data folder in the storage device 101.

Meanwhile, the buyer terminal 300 in a purchase division of a buyer, to which the invoice data 125 described above is addressed, issues an invoice inquiry instruction to the platform server 100 (s101), and acquires the invoice data 125 from the platform server 100 (s102). In this event, the buyer terminal 300 stores the invoice data 125 acquired from the platform server 100 in the storage device 301 of its own.

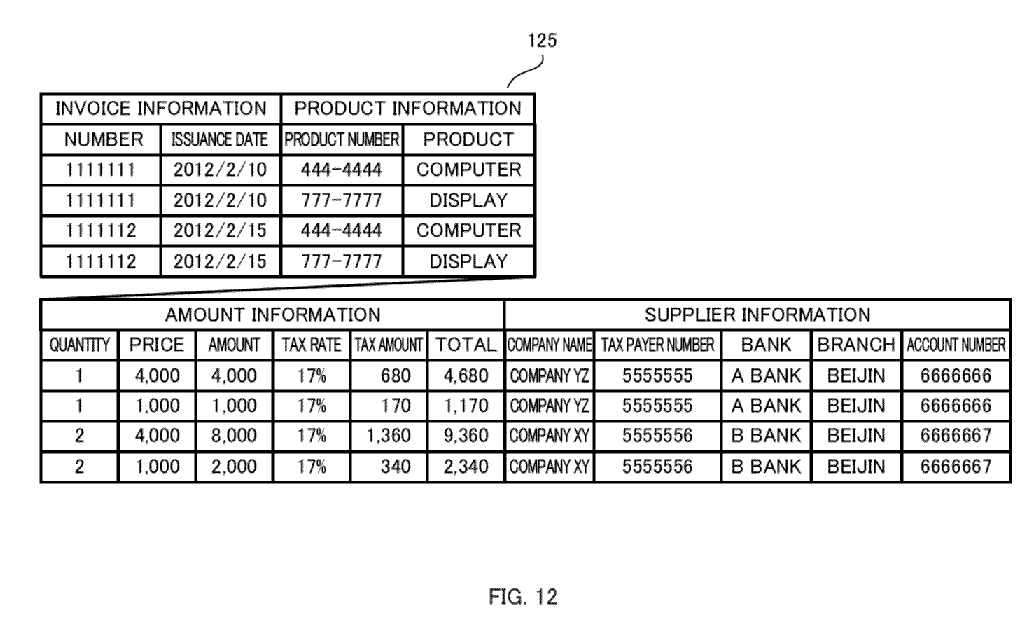

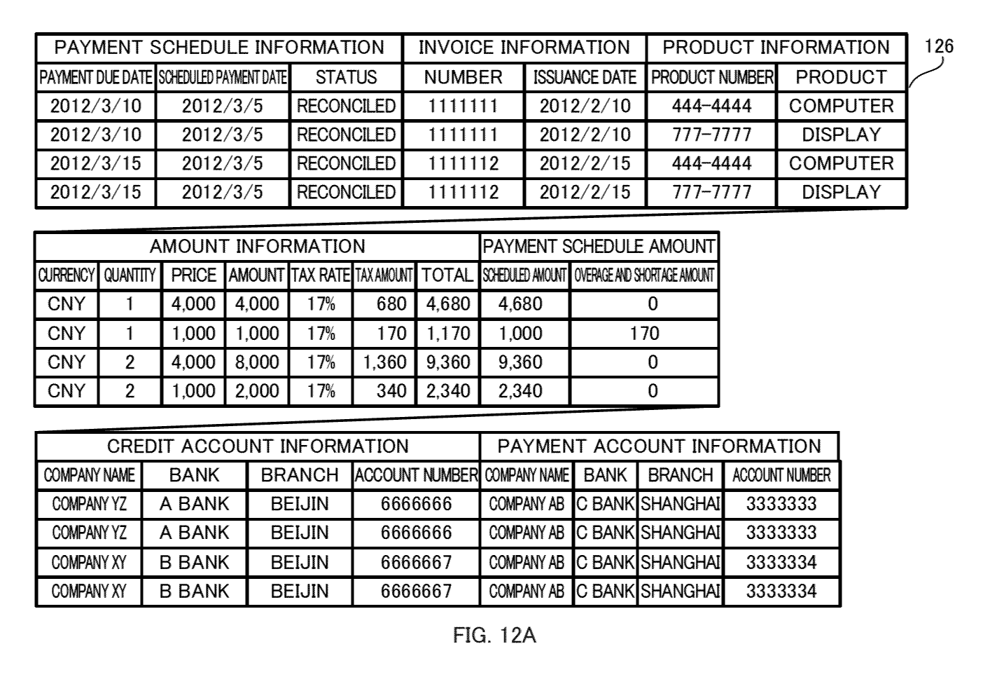

FIG. 12 shows an example of the invoice data 125. The invoice data 125 is a collection of records linking product information, amount information and supplier information with invoice information as a key. Among the above, the invoice information includes unique identification numbers of invoices and dates of issuance of the invoices. The product information includes information such as a product number and a product name, which are identification information of a product to be charged for. The amount information includes information of values such as quantity, price, amount (quantity×price), tax rate and sum, on each of products included in the product information described above. The supplier information includes a company name of a supplier company that is a seller of each product, a taxpayer number thereof and information of a bank account to which payment for each product included in the product information described above is to be made.

Meanwhile, the buyer terminal 300 generates payment schedule data 126 addressed to the supplier by attaching predetermined settlement information or settlement information specified by a predetermined person in charge in the buyer company using the input device 301 to the invoice data 125 stored in the storage device 301, and transmits the payment schedule data 126 to the platform server 100 (s103). Note that examples of the above settlement information to be attached to the invoice data 125 may include information of an invoice payment due date, information of a scheduled payment date determined by the buyer, payment account information that is information of a bank account used by the buyer company for settlement fund transfer, and the like. Note that the scheduled payment date may be calculated by subtracting a certain number of days from the value of the invoice issuance date.

FIG. 12A shows an example of the payment schedule data 126. The payment schedule data 126 is a collection of records linking together payment schedule information, invoice information, product information, amount information, amount to be paid, credit account information and payment account information. Among these information, the payment schedule information, the amount to be paid and the payment account information are the information different from the invoice data 125 described above.

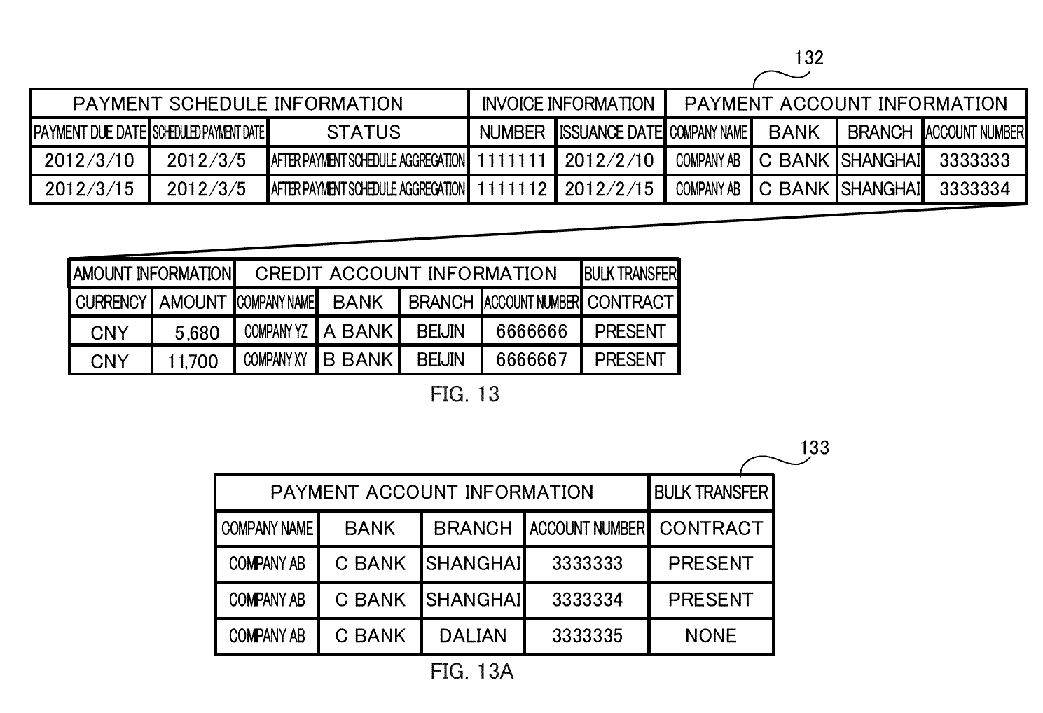

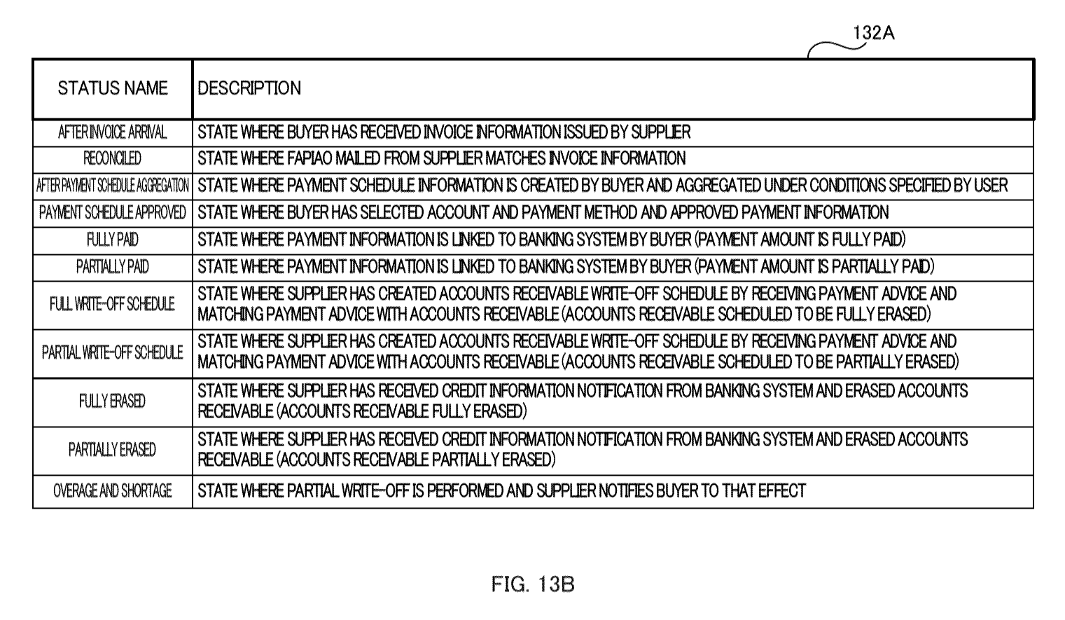

The payment schedule information includes the information of the payment due date included in the invoice data 125, the information of the scheduled payment date determined by the buyer included in the invoice data 125, and a status. Note that the scheduled payment date may be calculated by subtracting a certain number of days from the value of the invoice issuance date. The status information indicates a stage of processing performed on a relevant record in the payment schedule data 126. In the example shown in FIG. 12A, a value indicating whether or not the buyer has reconciled the content indicated by (the relevant record in) the invoice data 125 and the content indicated by a paper invoice held by the buyer is set. FIG. 13B shows an example of a status value list 132A. If the status value is subsequently updated according to each processing, the platform server 100 executes the update based on the list 132A shown in FIG. 13B.

As for the amount to be paid, a value of an amount to be paid to the supplier by the buyer is set for the relevant record in the payment schedule data 126. Normally, the value of the amount set here is the same as the sum value in the amount information. However, depending on the judgment of the buyer considering a situation of insufficient credit balance, change in the contract detail or the like, a value that is not the same as the sum value in the amount information may be set. These values are inputted using the input device 306 in the buyer terminal 300 by a predetermined person in charge in the buyer company.

The payment account information is the information of the bank account used by the buyer company for settlement fund transfer, and includes a company name of the buyer company and information of a bank account from which withdrawal of payment for a product is made.

Note that a paper invoice containing some of the information included in the invoice data 125 described above is mailed from the supplier company to the buyer company, separately from the electronic invoice data 125. Examples of the paper invoice include a fapiao used in China. In FIGS. 5, 7 and 8, the paper invoice is described as “fapiao”. The fapiao is an invoice or receipt in China, and a legal fapiao form issued by a tax agency is used. The buyer company receives the fapiao from the supplier company and stores the fapiao.

Meanwhile, the supplier terminal 200 executes normal journalization based on the invoice data 125, the fapiao and the like (s104), and uploads accounts receivable information 127 generated by the journalization to the platform server 100. Moreover, a general ledger 128 (denoted by “GL” in the drawings) is created as usual along with the journalization (s104). The general ledger 128 is stored in the storage device 201 in the supplier terminal 200.

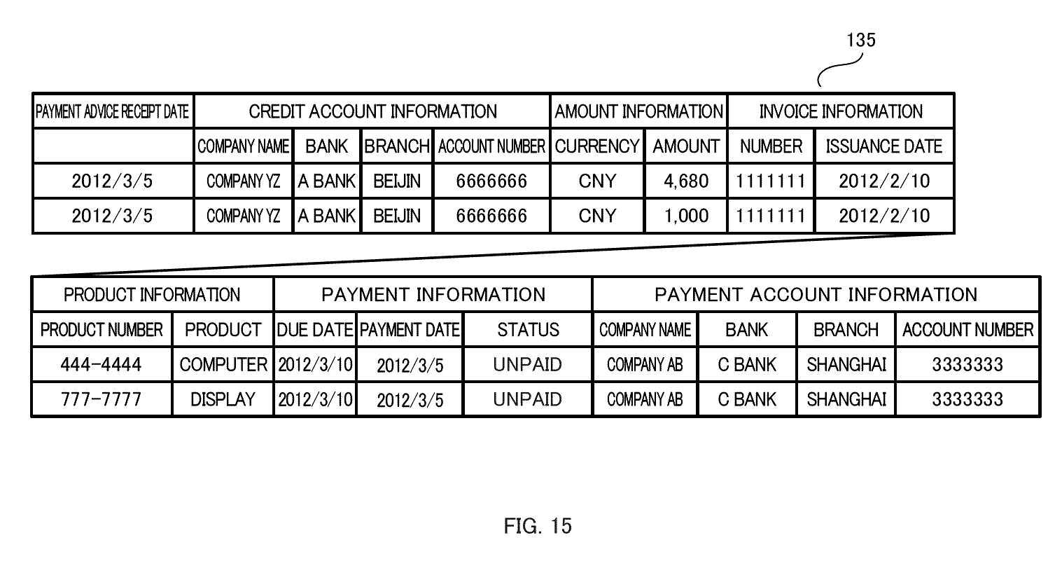

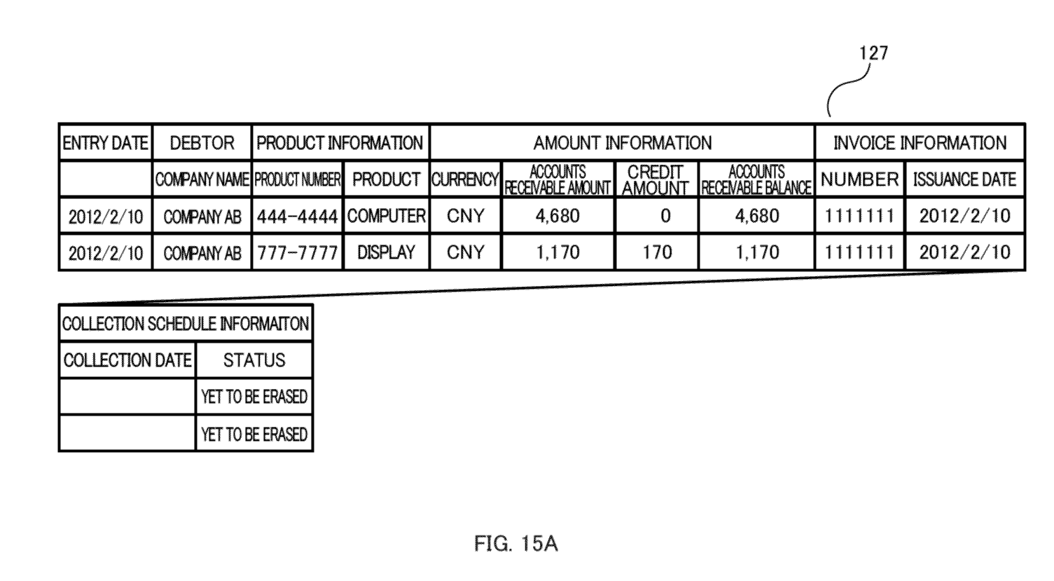

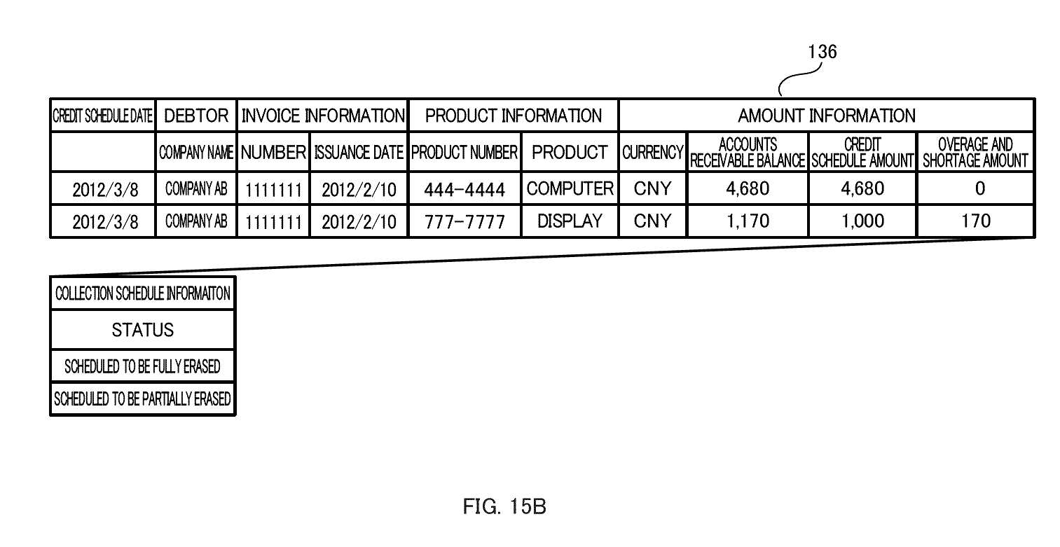

On the other hand, the platform server 100 receives the accounts receivable information 127 from the supplier terminal 200, and stores the accounts receivable information 127 in the storage device 101. FIG. 15A shows an example of the accounts receivable information 127. The accounts receivable information 127 includes data such as an entry date, a debtor indicating a sale destination company, product information indicating the product number and product name of a product sold, amount information thereof, invoice information indicating identification information and issuance date in the invoice data 125 and collection schedule information. The collection schedule information includes status information indicating a collection date for the accounts receivable and a collection situation.

Note that, with the mailing of the fapiao described above, the predetermined person in charge in the buyer company needs to check the consistency between the fapiao and the invoice data 125 described above, in order to maintain transaction accuracy. Therefore, the buyer terminal 300 displays the invoice data 125 received from the platform server 100 on the output device 307 for the checking by the person in charge described above.

The person in charge compares the content of the paper fapiao with the invoice data 125 displayed on the output device 307 to perform a matching operation (reconcile) to check if respective values of corresponding items coincide with each other.

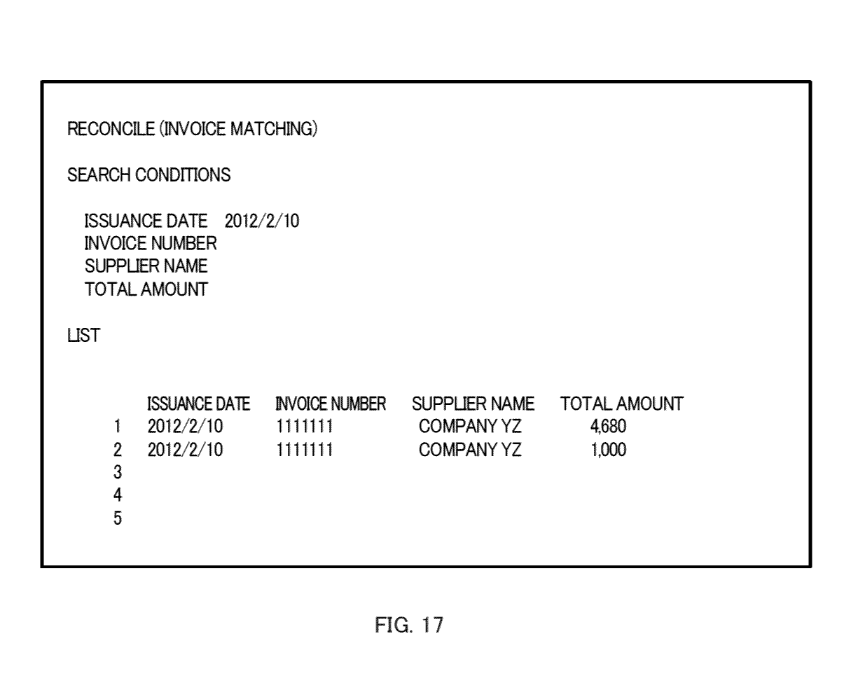

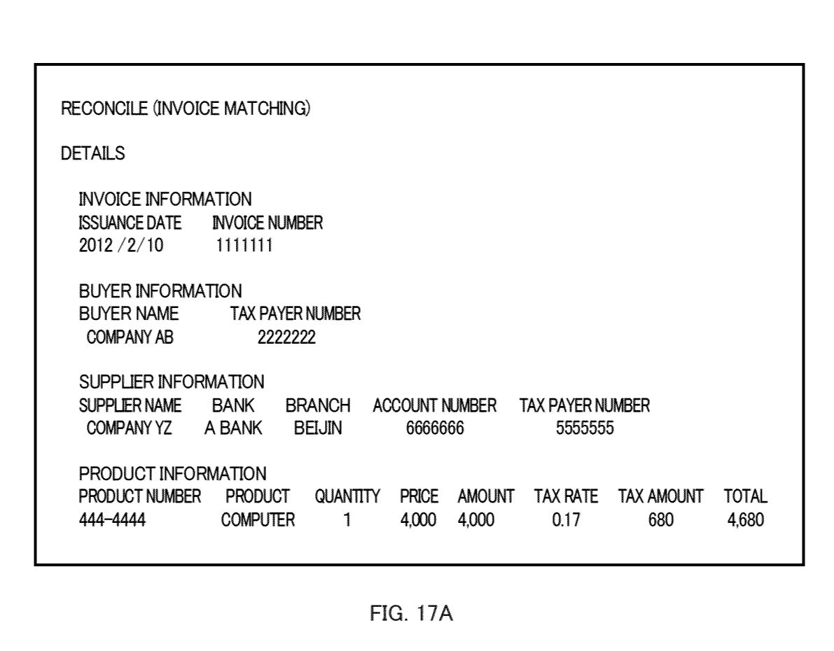

In this event, the buyer terminal 300 uses the input device 306 to receive a result of the matching by the buyer between the content of the invoice data 125 displayed on the output device 307 and the content of the paper fapiao (s105). FIGS. 17 and 17A show examples of a reconcile screen. FIG. 17 shows a list of the invoice data 125 to be processed. FIG. 17A shows detailed information of one of the invoice data 125.

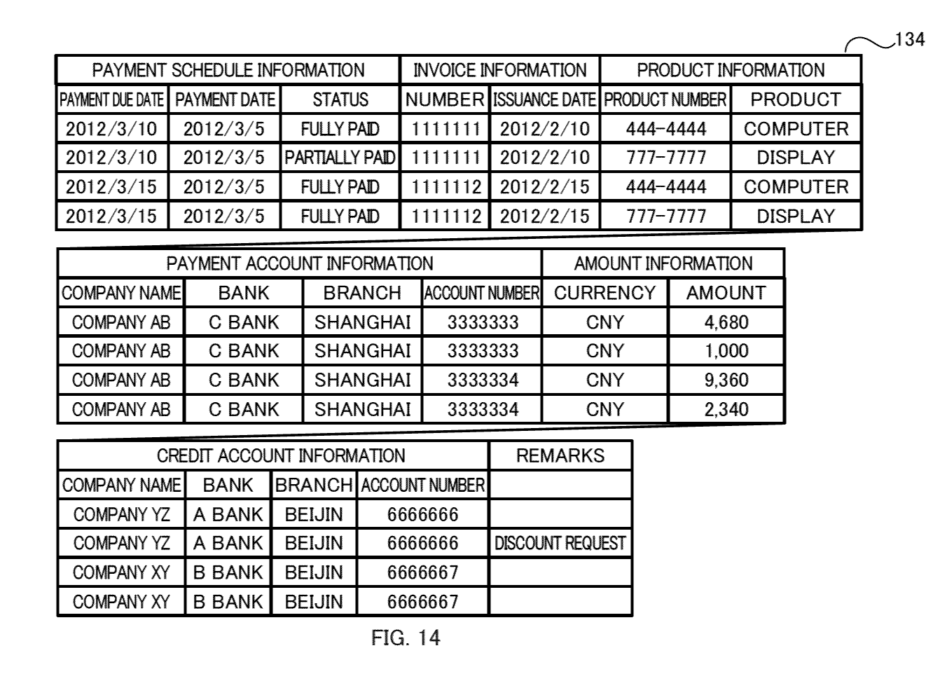

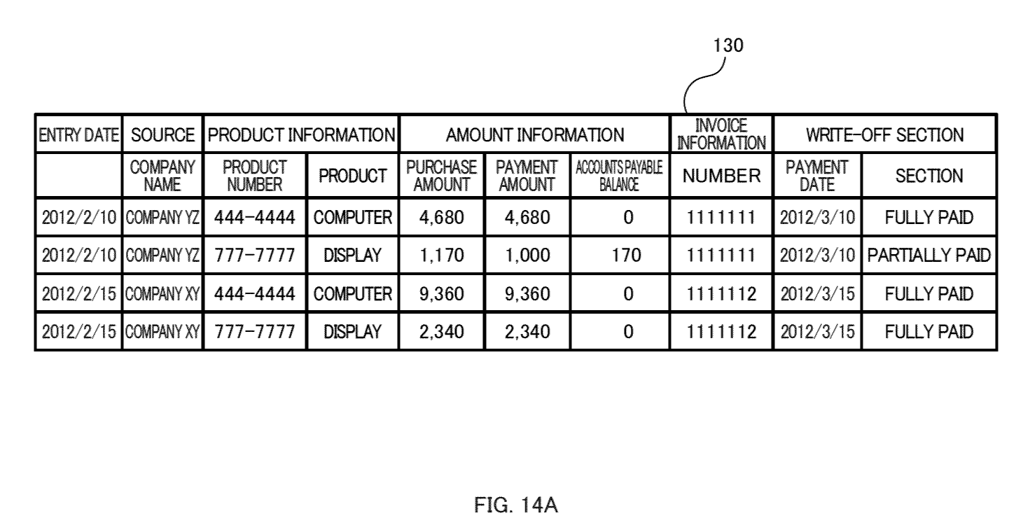

When the above result received by the input device 306 shows that there is no difference between the content of the invoice data 125 and the content of the paper fapiao (s106: Y), the buyer terminal 300 performs journalization based on the invoice data 125 described above (s109), generates accounts payable information 130 (see FIG. 14A), and transmits the accounts payable information 130 to the platform server 100. Along with this processing, the buyer terminal 300 also updates the status of the relevant record to “reconciled” in the payment schedule data 126. Note that a normal general ledger 131 (denoted by “GL” in the drawings) is created by the journalization in Step s109 described above.

Note that the accounts payable information 130 described above includes data such as an entry date, a supplier indicating a purchase destination company, product information indicating the product number and product name of a product purchased, amount information thereof, invoice information indicating identification information in the invoice data 125 and an write-off section indicating a payment situation for the accounts payable, as shown in FIG. 14A. In the example of FIG. 14A, the value of “write-off section” is “fully paid” or “partially paid”. Since the accounts payable information 130 is created based on the invoice data 125, the configuration thereof other than the value of “write-off section” indicating the presence or absence of write-off is the same as that of the invoice data 125.

On the other hand, when the above result received by the input device 306 shows that there is a difference between the content of the invoice data 125 and the content of the paper fapiao (s106: N), the buyer terminal 300 transmits information of the difference, i.e., difference information 129 to the platform server 100 (s107). The difference information 129 is data including the name of an item with the difference and respective values regarding the item in the invoice data 125 and the paper fapiao, for example.

Meanwhile, the platform server 100 receives the difference information 129 from the buyer terminal 300, and stores the difference information 129 in the storage device 101. The platform server 100 also transmits a confirmation request for the difference information 129 to the supplier terminal 200 (s108). On the supplier side, the supplier terminal 200 confirms the difference information 129, and a predetermined person in charge takes necessary measures after determining a subsequent response such as correction and reissuance of the fapiao or correction and re-uploading of the invoice data 125.

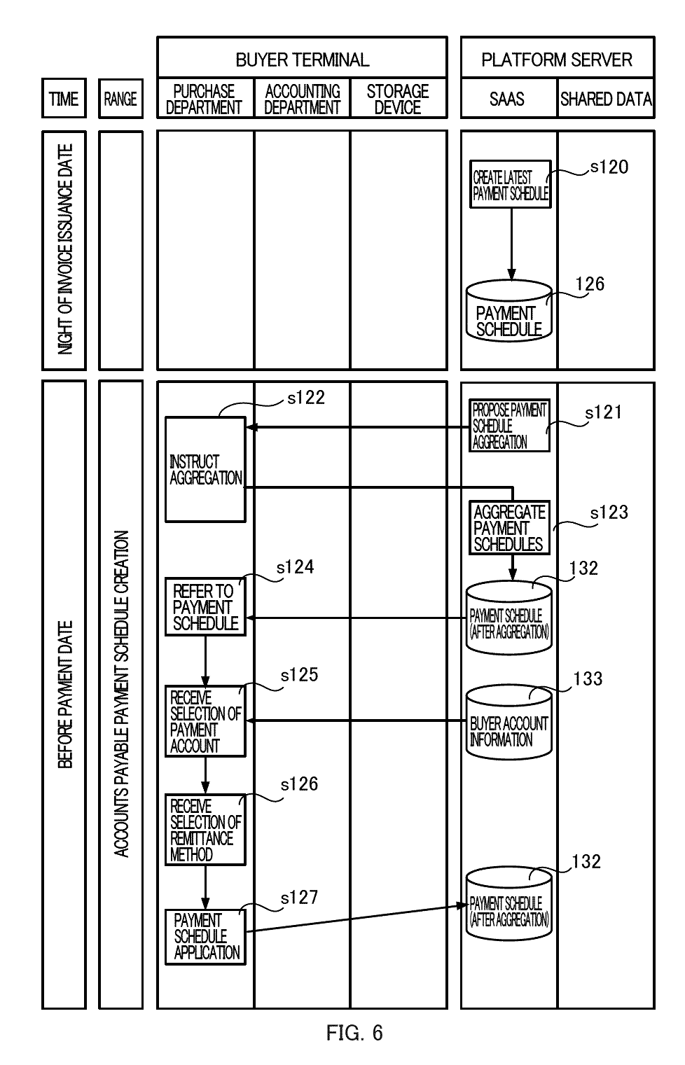

Next, with reference to the drawings, description is given of aggregation processing of the payment schedule data 126. FIG. 6 is a data flowchart showing procedure example 2 of the settlement operations support method according to this embodiment. In this case, as shown in FIG. 6, the platform server 100 repeats processing of the payment schedule data 126 described above for each of the latest invoice data 125 received from the supplier terminal 200 until the night of the invoice issuance date, for example, and accumulates records of the payment schedule data 126 in the storage device 101 (s120).

Here, the platform server 100 notifies the buyer terminal 300 of a payment schedule aggregation proposal by detecting that a certain number or more of records of the payment schedule data 126 are accumulated in the storage device 101, for example (s121). In this event, upon receipt of the notification, the buyer terminal 300 returns an aggregation instruction for the payment schedule data 126 to the platform server 100 (s122). The aggregation instruction may be inputted using the input device 306 in the buyer terminal 300 by a predetermined person in charge in the buyer company, and the buyer terminal 300 that has received the input may transmit the aggregation instruction to the platform server 100.

Upon receipt of the aggregation instruction for the payment schedule information from the buyer terminal 300, the platform server 100 reads the payment schedule data 126 regarding the buyer from the storage device 101 based on the value of “company name” and the like indicated by “payment account information” described above, specifies the payment schedule data 126 having a common predetermined item or predetermined item specified by the buyer terminal 300 among the read payment schedule data 126, merges the payment schedule data 126 by summing up the payment amounts in the specified payment schedule data 126, and stores the merged payment schedule data as post-aggregation payment schedule data 132 in the storage device 101 (s123).

Examples of the predetermined item used to specify the payment schedule data 126 to be aggregated include “payment due date” in “payment schedule information”, “scheduled payment date” in “payment schedule information”, “number” in “invoice information”, “company name” in “credit account information”, “bank”, “branch” and “account number”.

It is assumed that such predetermined items are “bank”: A bank with “account number”: 66666666 and “bank”: B bank with “account number”: 66666667. In such a case, the platform server 100 specifies two records from the top and two records from the bottom as data to be aggregated, among the payment schedule data 126 shown in FIG. 12A. Moreover, as for each two records, “scheduled amount” in “payment schedule information” is summed to calculate the value “amount” in “amount information” in the post-aggregation payment schedule data 132. FIG. 13 shows an example of the post-aggregation payment schedule data 132. The post-aggregation payment schedule data 132 shown in FIG. 13 is obtained by aggregating four records in the payment schedule data 126, two by two, and thus has two records.

Moreover, the platform server 100 sends an inquiry notification for the post-aggregation payment schedule data 132 generated as described above to the buyer terminal 300. Upon receipt of the notification, the buyer terminal 300 acquires the post-aggregation payment schedule data 132 from the platform server 100 and displays the post-aggregation payment schedule data on the output device 307 (s124), and then receives, using the input device 306, a payment account selection instruction from a predetermined person in charge (s125).

In this event, the buyer terminal 300 reads buyer account information 133 (see FIG. 13A) from the platform server 100, and displays the buyer account information 133 as a payment account selection list on the output device 307. Moreover, according to the selection of the payment account, the person in charge selects a desired mode of remittance (e.g.: individual transfer and bulk transfer) from among various transfer methods provided by the relevant bank.

The buyer terminal 300 receives the selected item through the input device 306 (s126) and notifies the platform server 100 of a payment schedule application including the selected item and the payment account selected item acquired in Step s125 (s127).

The platform server 100 receives the payment schedule application from the buyer terminal 300, acquires a value “bulk transfer” (bulk transfer mode), for example, as the value of the mode of remittance included in the application, and sets the value in the appropriate column “bulk transfer” in the post-aggregation payment schedule data 132 described above. In the example of FIG. 13, a value indicating the presence or absence of contract for the bulk transfer mode with the relevant bank is set in the column “bulk transfer”. Moreover, the platform server 100 sets the value of the payment account selected item included in the payment schedule application in the appropriate column “payment account information” in the post-aggregation payment schedule data 132.

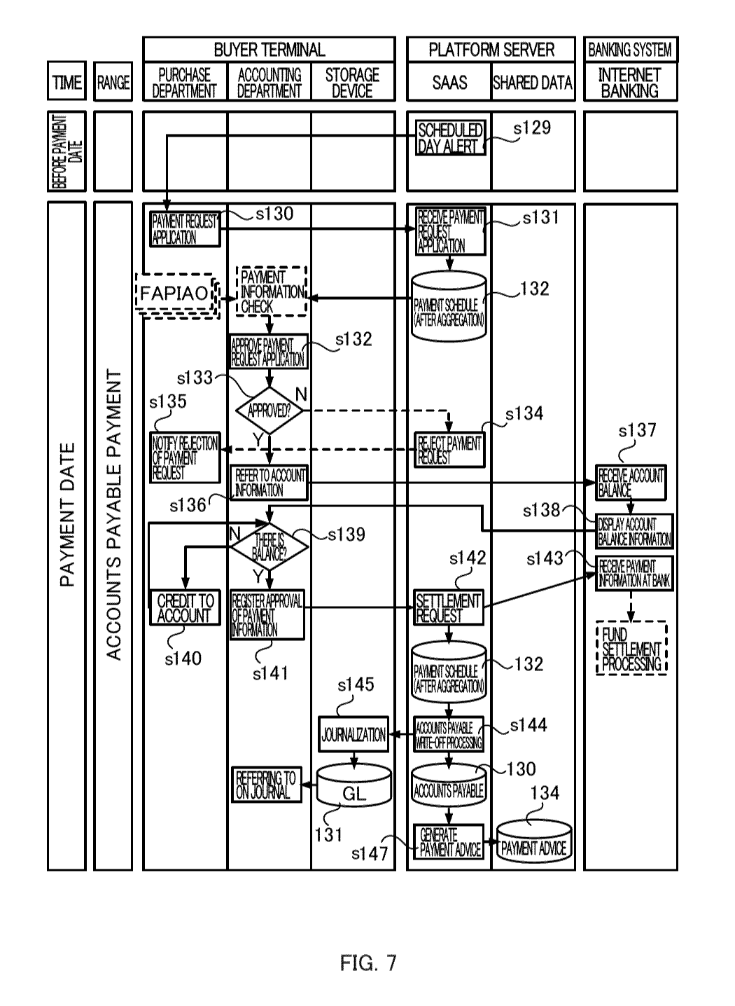

Next, with reference to the drawings, description is given of processing upon arrival of a day for actual payment by the buyer, i.e., “scheduled payment date” in the post-aggregation payment schedule data 132. FIG. 7 is a data flowchart showing procedure example 3 of the settlement operations support method according to this embodiment.

In this case, for example, the platform server 100 uses its own calendar function to detect the arrival of “scheduled payment date” in the post-aggregation payment schedule data 132, and notifies the buyer terminal 300 to that effect (s129). Upon receipt of the notification, the buyer terminal 300 transmits a payment request application to the platform server 100 (s130). Needless to say, a predetermined person in charge in the buyer company may input the payment request application data using the input device 306 in the buyer terminal 300, and the buyer terminal 300 may transmit the inputted data to the platform server 100.

Meanwhile, the platform server 100 receives the payment request application from the buyer terminal 300 (s131), reads post-aggregation payment schedule data 132 (e.g.: the value of “company name” in the column “payment account information” is “company name AB”) regarding a relevant buyer (e.g.: company name AB) from the storage device 101, and sends the read data to the buyer terminal 300.

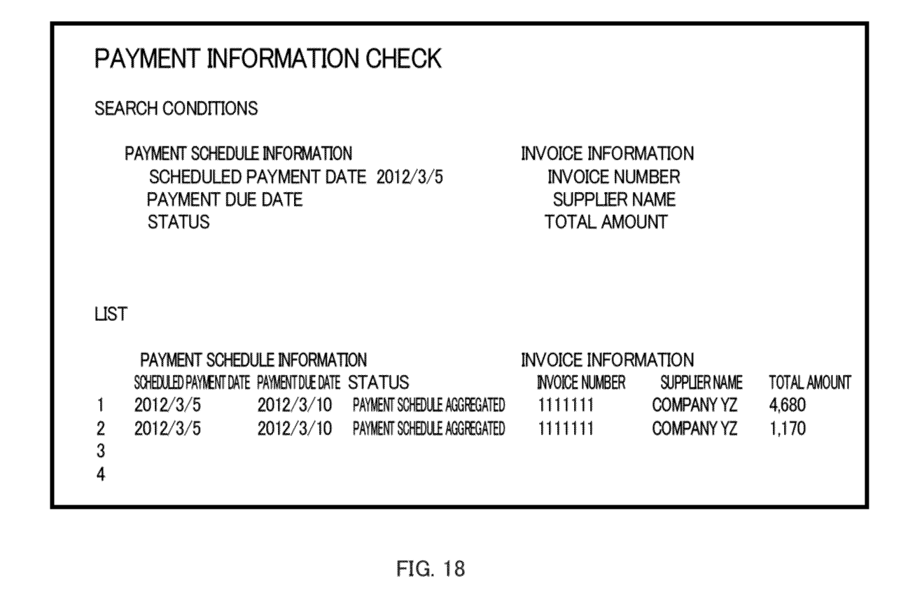

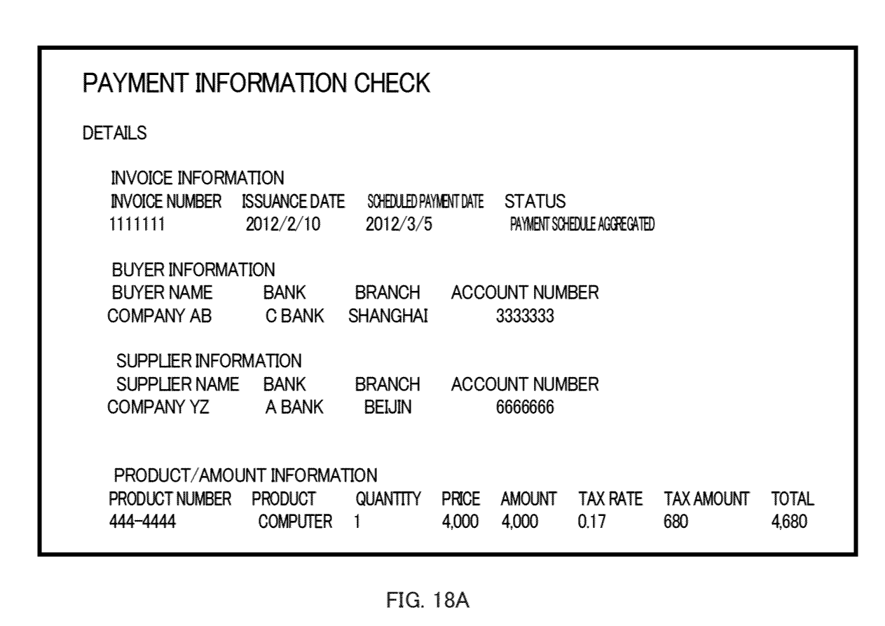

The buyer terminal 300 acquires the post-aggregation payment schedule data 132 from the platform server 100, and displays the data on the output device 307 (FIGS. 18 and 18A). In this case, the buyer terminal 300 receives, through the input device 306, a result of determination on acceptability of a payment request by the buyer checking the content of the post-aggregation payment schedule data 132 against the content of the paper invoice, i.e., fapiao sent from the supplier to the buyer (s132). Such determination on the acceptability of the payment request is executed by a person in charge of the accounting department of the buyer company.

When the acceptability determination result received through the input device 306 does not approve the payment request (s133: N), the buyer terminal 300 transmits a rejection notification of the payment request to the platform server 100, and transmits the rejection to a predetermined terminal such as the buyer terminal 300 in the purchase division of the buyer company (s135).

On the other hand, when the acceptability determination result received through the input device 306 approves the payment request (s133: Y), the buyer terminal 300 checks the balance in a relevant account (e.g.: Shanghai branch, account number 3333333) through predetermined login authentication at the banking system 400 of a bank (e.g.: C bank) indicated by “payment account information” in the post-aggregation payment schedule data 132 (s136).

Upon receipt of the balance inquiry (s137), the banking system 400 returns the value of the balance of the account to the buyer terminal 300 (s138). The buyer terminal 300 determines whether or not the value of the balance of the account satisfies the value of “scheduled amount” in the post-aggregation payment schedule data 132 (s139). When determining that there is a balance required (s139: Y), the buyer terminal 300 transmits an approval registration instruction regarding the payment request to the platform server 100 (s141). On the other hand, when determining that the value of the balance of the account is below “scheduled amount” and there is no balance required (s139: N), the buyer terminal 300 credits an amount corresponding to the shortage to the relevant account from another bank account held by the buyer company, for example (s140), and then returns the processing to Step s139.

Meanwhile, upon receipt of the approval registration instruction transmitted from the buyer terminal 300 in Step s141, the platform server 100 transmits a settlement transaction request, to the banking system 400 of the bank (e.g.: C bank) used by the buyer indicated by the post-aggregation payment schedule data, corresponding to the amount indicated by “amount information” from the account indicated by “payment account information” in the post-aggregation payment schedule data 132 to the bank account indicated by “credit account information” (s142). Upon receipt of the settlement transaction request (s143), the banking system 400 executes a predetermined settlement transaction by performing transfer from the account of the buyer company to the account of the supplier company, and the like.

Moreover, along with the processing of transmitting the settlement transaction request to the banking system 400, the platform server 100 specifies, using the storage device 101, accounts payable information 130 (see FIG. 14A) corresponding to “number” in “invoice information” in the post-aggregation payment schedule data 132 included in the settlement transaction request, and executes write-off processing of the accounts payable information (s144). In the example of FIG. 14A, the value of “write-off section” in the accounts payable information 130 is “fully paid” or “partially paid”. Since the accounts payable information 130 is created based on the invoice data 125, the configuration thereof other than the value of “write-off section” indicating the presence or absence of write-off is the same as that of the invoice data 125.

Note that the platform server 100 notifies the buyer terminal 300 of a result of the write-off processing of the accounts payable information 130. Upon receipt of the notification, the buyer terminal 300 executes journalization according to the accounts payable information subjected to the write-off (s145), and updates the general ledger 131. The person in charge of the accounting department of the buyer company can use the buyer terminal 300 to refer to the general ledger 131.

After executing the write-off processing of the accounts payable information, the platform server 100 generates a payment advice (see FIG. 14) regarding (the records of) the invoice data 125 for which the settlement transaction request has been made (s147), and transmits the payment advice 134 to the supplier terminal 200. The payment advice 134 has the same data configuration as that of (the records of) the invoice data 125 for which the settlement transaction request has been made. However, in the example of FIG. 14, the value of “status” in the payment advice 134 is “fully paid” when the amount paid by the buyer coincides with the amount charged by the supplier or “partially paid” when the amount paid by the buyer falls short of the amount charged by the supplier.

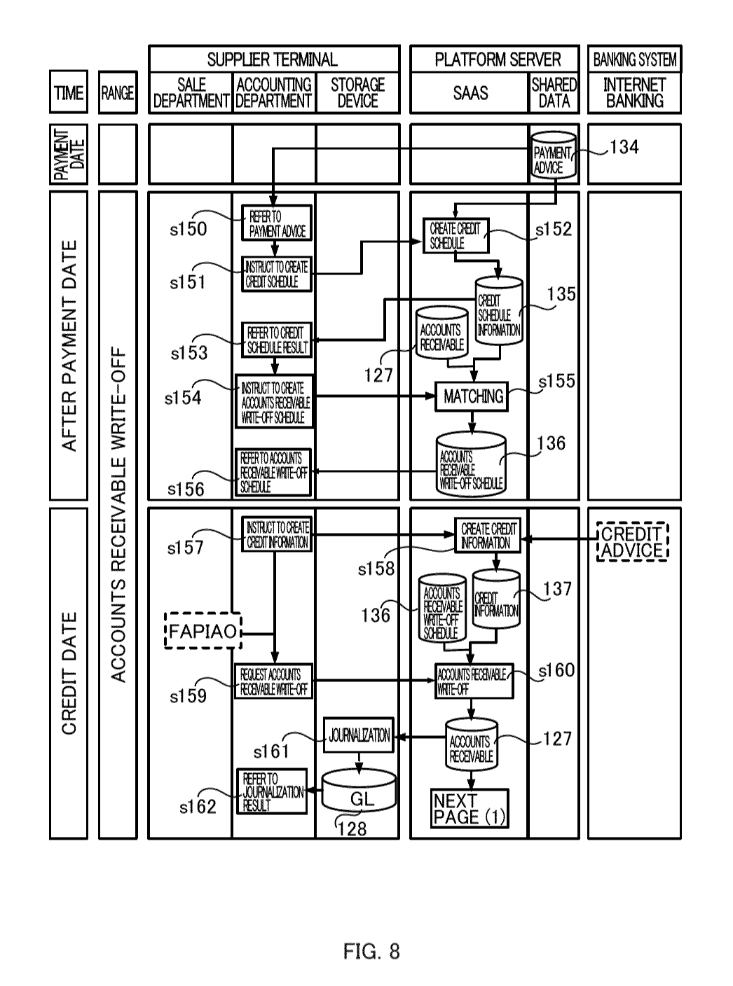

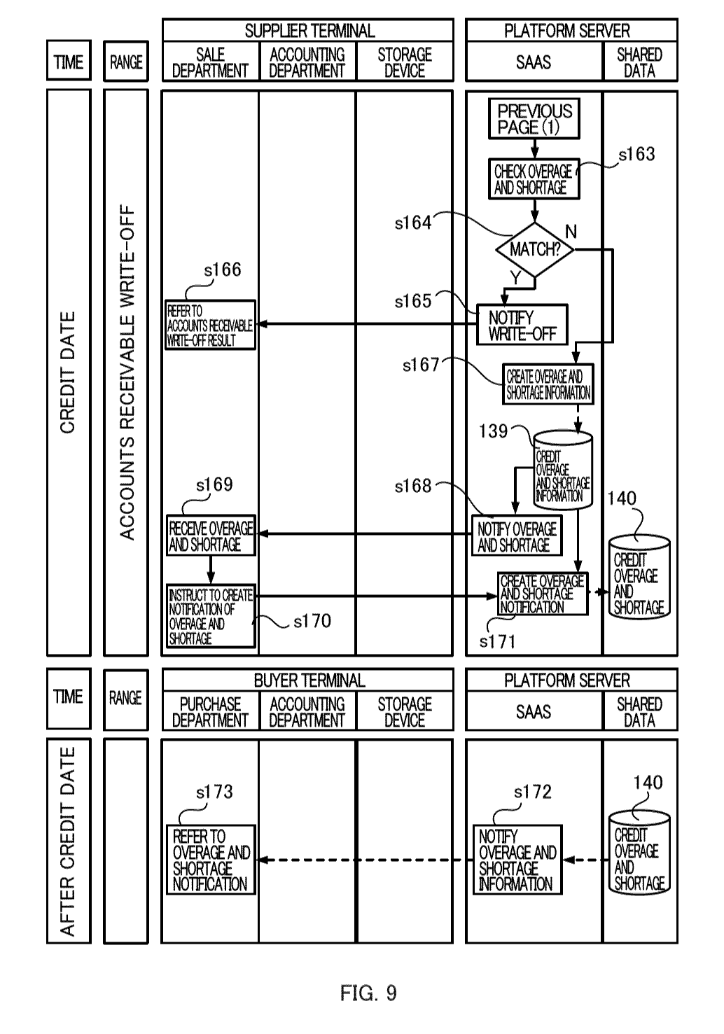

Next, with reference to the drawings, description is given of write-off processing of accounts receivable. FIG. 8 is a data flowchart showing procedure example 4 of the settlement operations support method according to this embodiment. FIG. 9 is a data flowchart showing procedure example 5 of the settlement operations support method according to this embodiment. In this case, upon generation of the payment advice 134 or according to an instruction to refer to or create a payment advice from the supplier terminal 200 (s150, s151), the platform server 100 generates credit schedule information 135 (s152) and stores the credit schedule information 135 in the storage device 101.

The credit schedule information 135 is generated based on information of payment details to the supplier included in the settlement transaction request or the payment advice 134. As shown in FIG. 15, the credit schedule information 135 includes data on a payment advice receipt date that is the day the payment advice is created upon receipt of a settlement request from the buyer terminal 300, credit account information indicating the account of the supplier company receiving credit from the buyer company, amount information indicating the amount paid, invoice information indicating the number and issuance date of corresponding invoice data 125, product information indicating the product number and product name of a product to be paid for, payment information indicating a payment due date, an actual payment date and a payment status, and payment account information indicating the account used for payment by the buyer company. In the case of the example shown in FIG. 15, “status” in the credit schedule information 135 is “unpaid”. At this point, the status is a state where a credit is scheduled and the platform server 100 has received no actual credit notification from the banking system 400.

Moreover, the platform server 100 notifies the supplier terminal 200 of the generation of the credit schedule information 135. Upon receipt of the notification, the supplier terminal 200 acquires the credit schedule information 135 from the platform server 100 (s153), and receives, through the input device 206, an instruction from the person in charge of the accounting department who has reviewed the credit schedule information. This instruction is an instruction to prepare a write-off schedule for accounts receivable. This preparation instruction is transmitted from the supplier terminal 200 to the platform server 100 (s154).

In this case, upon receipt of the preparation instruction from the supplier terminal 200, the platform server 100 reads the credit schedule information 135 and the accounts receivable information 127 (see FIG. 15A) stored in the storage device 101, and specifies (matches), using the storage device 101, (the records of) the accounts receivable information 127 corresponding to the identification information in the invoice data 125, i.e., the value of “number” in “invoice information” (s155). Note that the accounts receivable information 127 is generated from the invoice data 125, and includes data such as the entry date, debtor, product information, amount information, invoice information and collection schedule information as described above. The collection schedule information includes information of a collection date of the accounts receivable and a status indicating a collection situation thereof.

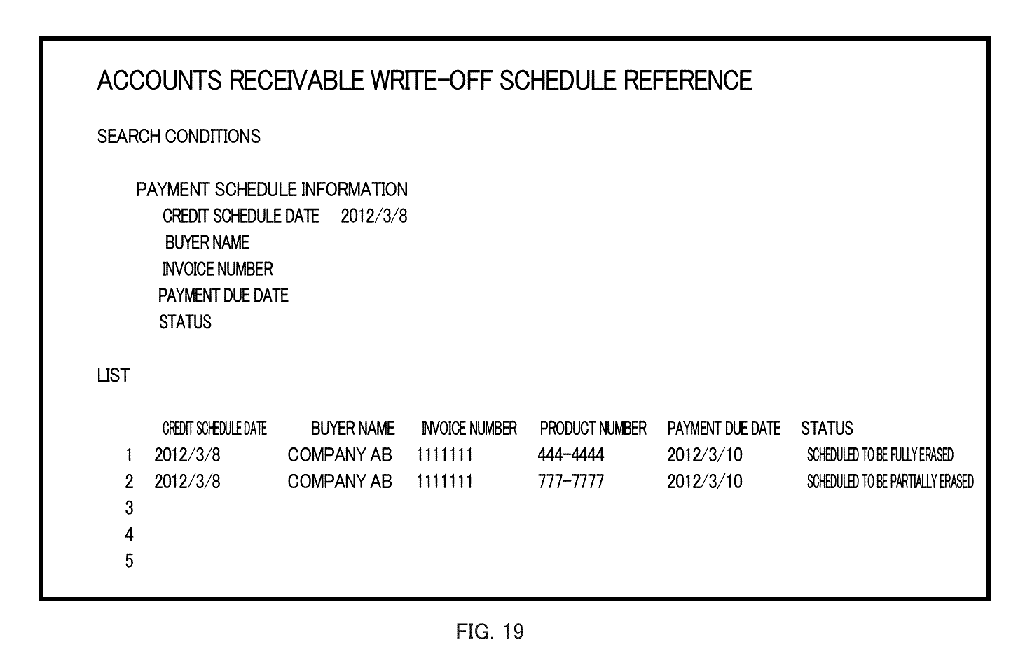

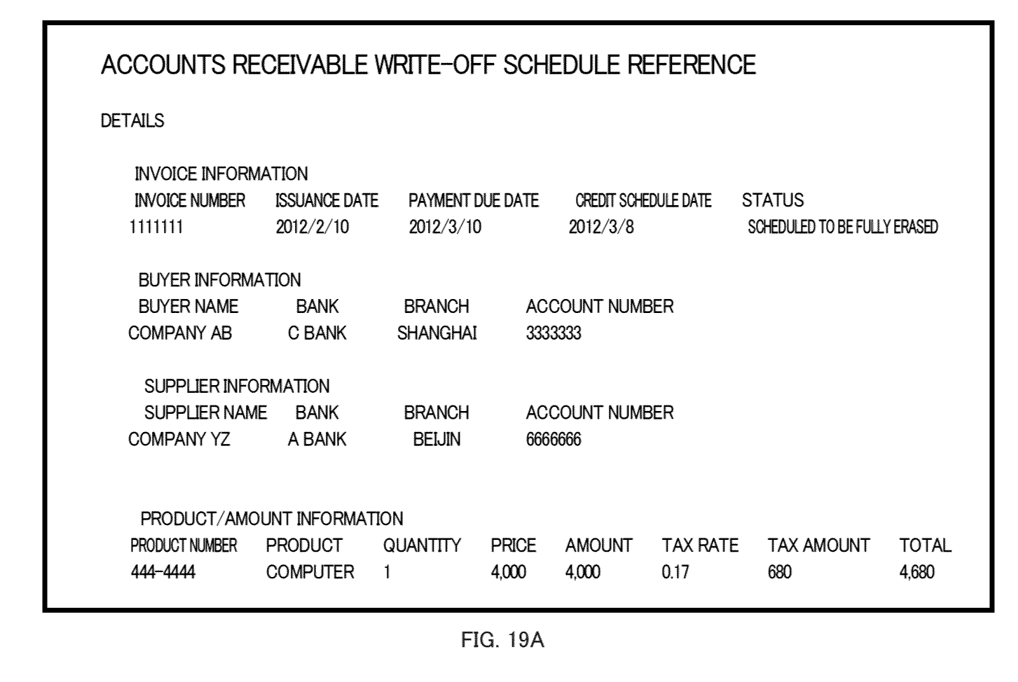

In this event, the platform server 100 generates accounts receivable write-off schedule information 136 (see FIG. 15B) specified in Step s155 described above. The accounts receivable write-off schedule information 136 has approximately the same data configuration as that of the accounts receivable information 127 described above, and includes the credit schedule date, debtor, invoice information, product information, amount information, and collection schedule information. Note that the supplier terminal 200 acquires the accounts receivable write-off schedule information 136 and displays the information on the output device 207 as shown in FIGS. 19 and 19A (s156) to be reviewed by the person in charge of the accounting department of the supplier company.

Next, description is given of processing when transfer to the bank account of the supplier specified in “credit account information” is actually executed from the bank account of the buyer specified in “payment account information” after the payment from the buyer company to the supplier company is executed as described above.

In this case, the banking system 400 of the bank of the supplier that has received the credit from the buyer transmits a credit notification indicating the fact of the credit to the platform server 100 and the supplier terminal 200.

Upon receipt of the credit notification, the supplier terminal 200 sends an instruction to create credit information 137 to the platform server 100 (s157).

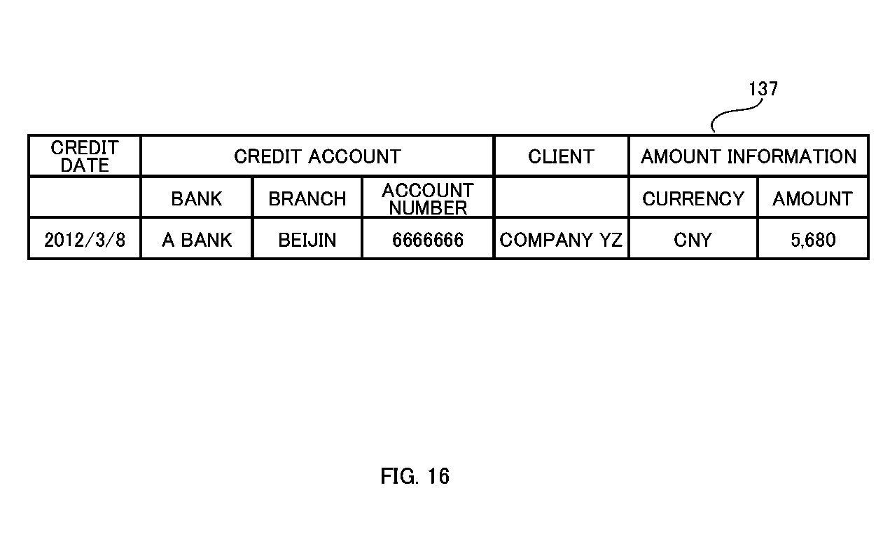

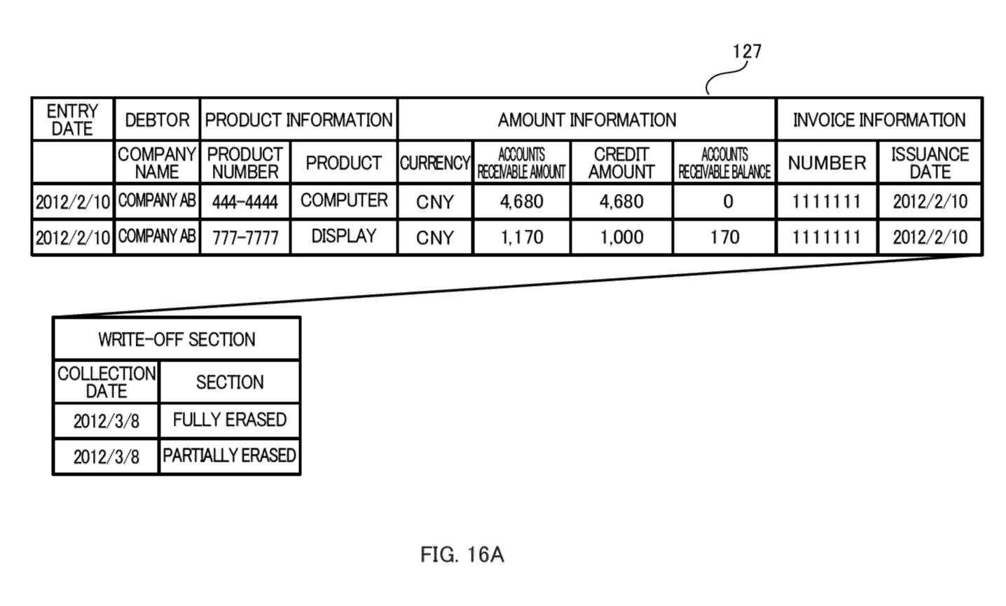

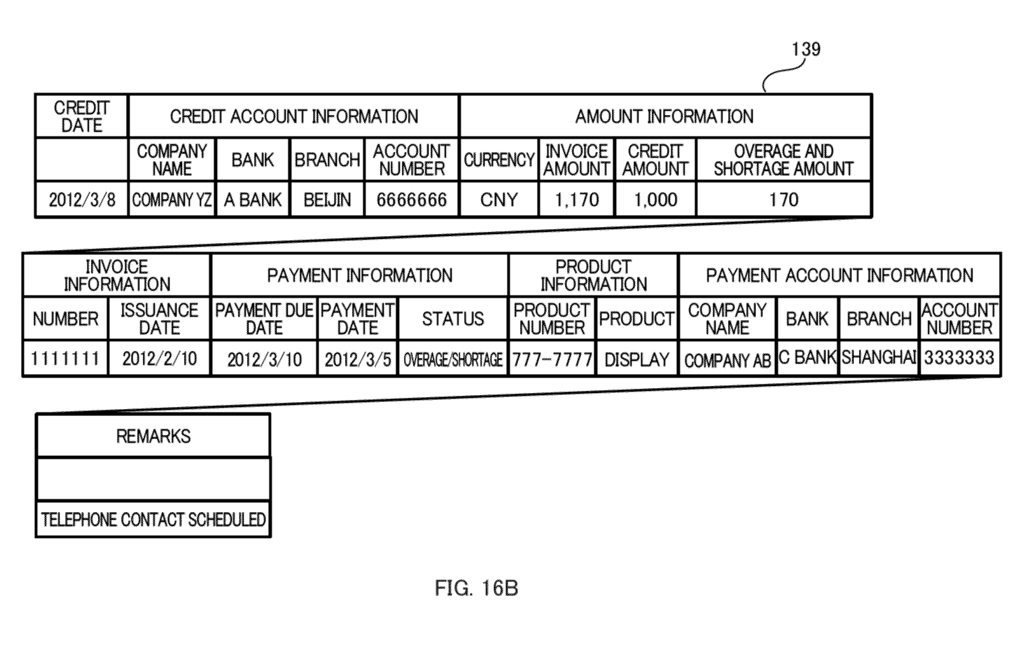

Meanwhile, the platform server 100 receives the credit notification regarding the account of the supplier, creates the credit information 137 based on the information indicated by the credit notification, and stores the credit information 137 in the storage device 101 (s158). As shown in FIG. 16, the credit information 137 includes data such as a credit date indicating the day credit is actually given to the bank, a credit account indicating the account to which the credit is given, a client of the credit, i.e., a client that is a company that has executed the transfer, and amount information indicating the credited amount.

On the other hand, after transmitting the credit information creation instruction to the platform server 100, the supplier terminal 200 displays the credit notification on the output device 207 for the person in charge of the accounting department of the supplier company to perform a matching operation with a fapiao. The person in charge of the accounting department checks the consistency between the content of the credit notification and the content of the fapiao. When determining that there is consistency therebetween, the person in charge of the accounting department inputs a write-off processing request instruction regarding the accounts receivable corresponding to the credit notification to the input device 206 in the supplier terminal 200.

Upon receipt of the write-off processing request instruction to the input device 206, the supplier terminal 200 transmits the instruction to the platform server 100 (s159). Meanwhile, upon receipt of the accounts receivable write-off request, the platform server 100 matches the credit information 137 with the accounts receivable write-off schedule information 136 to specify accounts receivable write-off schedule information 136 of the accounts receivable corresponding to the content of the credit notification, and uses the accounts receivable information 127 to execute write-off processing of the accounts receivable (s160). To be more specific, in this step, the platform server 100 uses the accounts receivable information 127 shown in FIG. 16A to set the value of “accounts receivable balance” in “amount information” to “0”, “170” or the like and to set the value of “section” in “write-off section” to “fully erased” or “partially erased”. The platform server 100 sends an accounts receivable write-off execution notification to the supplier terminal 200.

The supplier terminal 200 receives the accounts receivable write-off execution notification, executes journalization of the accounts receivable information 127 (s161), and updates the general ledger 128. The supplier terminal 200 receives an instruction from the person in charge of the accounting department of the supplier company to make an inquiry into the general ledger 131 (s162).

Meanwhile, after executing the accounts receivable write-off processing in Step s160 described above, the platform server 100 specifies accounts receivable information 127 or accounts receivable write-off schedule information 136 corresponding to the content of the credit notification, and determines whether or not there is overage or shortage of the credit amount for the specified accounts receivable (s163). In this case, the platform server 100 reads the value of “accounts receivable balance” in “amount information” and the value of “section” in “write-off section”, and searches for a record in which the value of “accounts receivable balance” is other than “0” or a record in which the value of “section” in “write-off section” is other than “fully erased”. When having succeeded in searching for the record, the platform server 100 determines that there is overage or shortage of the credit amount for the accounts receivable.

When there is no overage or shortage of the credit amount (s164: Y) as a result of the determination, the platform server 100 notifies the supplier terminal 200 of write-off of the specified accounts receivable (s165). Alternatively, when there is no overage or shortage of the credit amount (s164: Y), write-off processing of the specified accounts receivable may be executed. Note that, even when there is credit overage or shortage, the accounts receivable write-off processing may be performed. In this case, only the amount of the credit is erased in the case of shortage. Alternatively, transmission of overage and shortage amount information and the write-off may be both performed.

On the other hand, when there is overage or shortage of the credit amount (s164: N) as a result of the determination, the platform server 100 creates credit overage and shortage information 139 that is information of overage and shortage amounts (s167) and transmits the created information to the supplier terminal 200 (s168). FIG. 16B shows the credit overage and shortage information 139. The credit overage and shortage information 139 includes information of a credit date, credit account information, amount information, invoice information, payment information, product information, payment account information and remarks regarding the record of the accounts receivable information 127 with the overage or shortage of the credit amount (which can also be said to be the record of the original invoice data 125). As the information of “remarks”, the platform server 100 sets predetermined measures to be taken by the supplier company or the buyer company.

The supplier terminal 200 receives the credit overage and shortage information 139 from the platform server 100 (s169) and sends an instruction to create credit overage and shortage information 140, which is stored in a shared folder (a folder that can also be accessed by the buyer terminal 300) in the platform server 100, to the platform server 100 (s170). Upon receipt of the creation instruction, the platform server 100 makes a copy of the credit overage and shortage information 139, uses the copy as the credit overage and shortage information 140, and stores the information in a shared folder in the storage device 101 (s171). Moreover, the platform server 100 notifies the buyer terminal 300 of the overage and shortage information based on the credit overage and shortage information 140 (s172).

The buyer terminal 300 receives the notification of the overage and shortage information from the platform server 100, and displays the information on the output device 307 to be reviewed by the person in charge of the purchase department of the buyer company (s173). When detecting that there is overage or shortage of the credit amount, the supplier company and the buyer company execute post-processing, such as reconfirmation and correction of contract details and settlement of the amount for the overage or shortage, by contacting each other, for example.

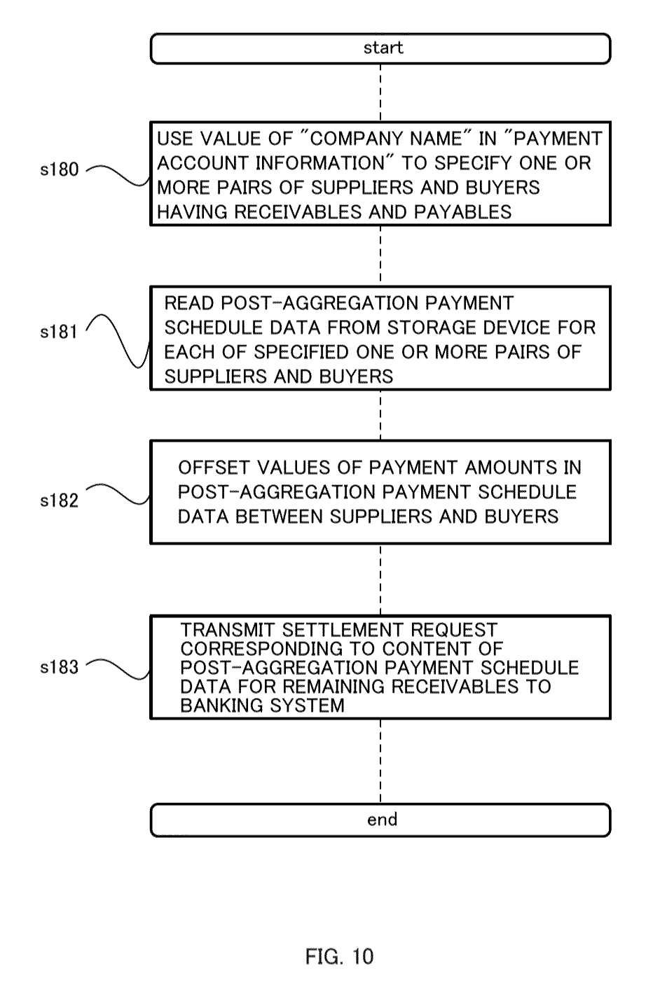

Next, with reference to the drawings, description is given of processing of offsetting settlement amounts. FIG. 10 is a flowchart showing procedure example 6 of the settlement operations support method according to this embodiment. Here, description is given of a method for offsetting remittance transactions linked to receivables (accounts receivable) and payables (accounts payable) held by participants in e-commerce in the platform server 100 and making settlement for only a difference on a certain due date. Such processing has an effect to reduce bank commissions and the effort of clerical work compared with the case where settlement is made for each transaction. Note that either a method of offsetting between two companies (bilateral netting) or a method of offsetting among three or more companies with a controlling company or the like as a mediator (multilateral netting) can be employed depending on the situation.

In this case, the platform server 100 uses the value of “company name” in “payment account information” as a key to specify one or more pairs of suppliers and buyers having receivables and payables, i.e., having the values of “company name” in “payment account information” in the invoice data 125, the payment schedule data 132 or the post-aggregation payment schedule data 132, which point to each other (s180).

Next, the platform server 100 reads the post-aggregation payment schedule data 132 from the storage device 101 for each of the specified one or more pairs of suppliers and buyers (s181) and offsets the values of the payment amounts in the post-aggregation payment schedule data 132 between the suppliers and the buyers (s182).

Moreover, the platform server 100 transmits a settlement transaction request corresponding to the content indicated by the post-aggregation payment schedule data 132 for remaining payables to the banking system 4 of the bank used by the supplier or the buyer, which is indicated by the payment schedule data 132 including only the content for the remaining payables left after offsetting (s183). The banking system 400 executes the settlement according to the request.

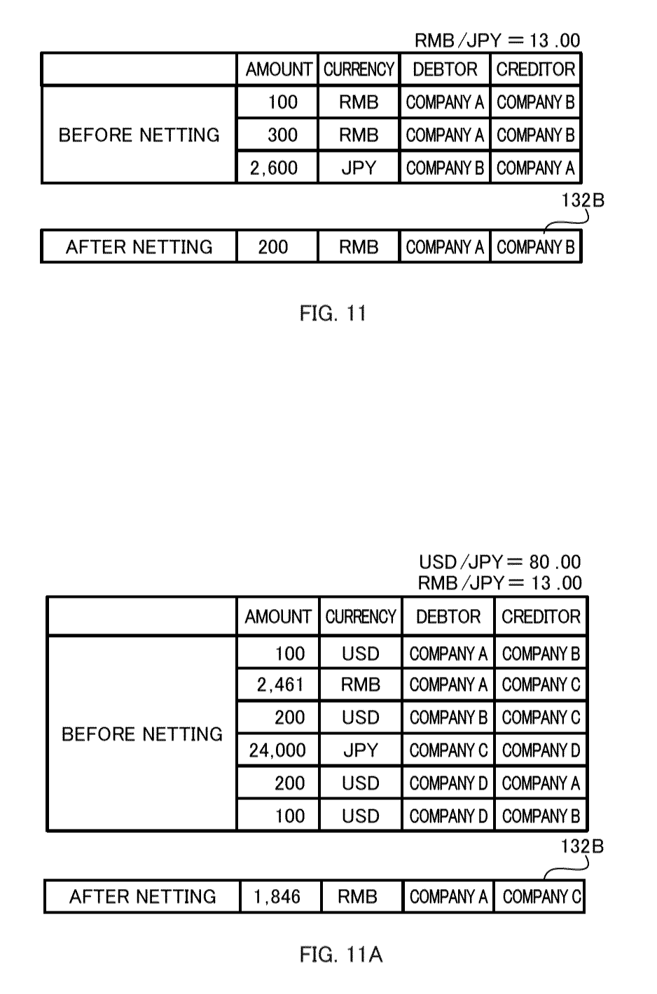

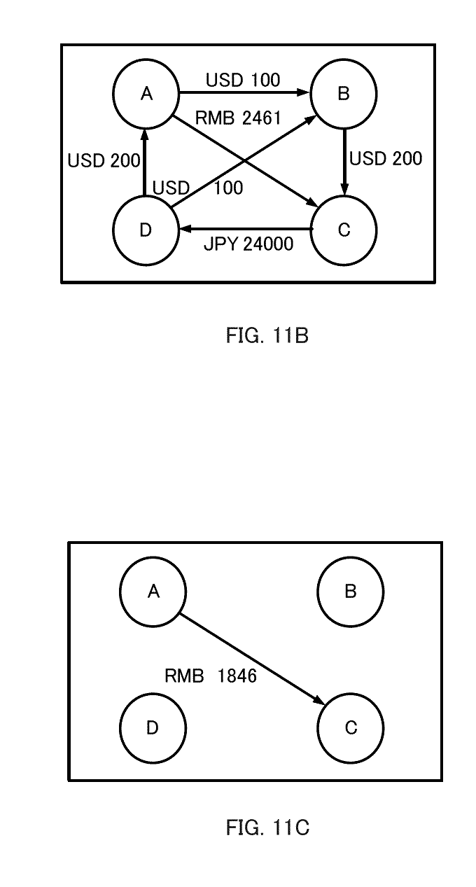

For example, when there is one pair of supplier and buyer specified in Step s180 described above, so-called bilateral netting is executed. It is assumed that Company A and Company B are conducting three transactions as shown in FIG. 11 before offsetting, i.e., netting payment amounts. When Step s182 described above is executed, “debtor” is “Company A”, “creditor” is “Company B” and remaining payables of the settlement amount is “200” in payment schedule data 132B including only the content of the remaining payables left after the offsetting, as shown in the lower part of FIG. 11. Thus, in the case of making settlement for each transaction in a conventional manner, three exchange/remittance transactions are required for the three transactions. On the other hand, only one transaction is required after netting.

Meanwhile, when there are two or more pairs of suppliers and buyers specified in Step s180 described above, so-called multilateral netting is executed. It is assumed that Company A, Company B, Company C and Company D are conducting six transactions as shown in FIGS. 11A and 11B before offsetting, i.e., netting payment amounts. When Step s182 described above is executed, “debtor” is “Company A”, “creditor” is “Company C” and remaining payables of the settlement amount is “1846” in payment schedule data 132B including only the content of the remaining payables left after the offsetting, as shown in the lower part of FIG. 11A and FIG. 11C. Thus, in the case of making settlement for each transaction in a conventional manner, six exchange/remittance transactions are required for the six transactions. On the other hand, only one transaction is required after netting. In other words, exchange/remittance transactions can be significantly reduced, and thus commissions can be reduced.

Although the best mode for carrying out the present invention, and the like have been described in detail above, the present invention is not limited thereto, but various changes can be made without departing from the scope of the present invention.

The embodiment of the present invention described above can improve the efficiency in various settlement operations and cost reduction by linking business-to-business transactions with bank transactions.

At least the following will become apparent from the description of the present specification. Specifically, in the settlement operations support method according to this embodiment, the terminal of the buyer executes processing of displaying invoice data received from the computer on an output device, receiving, through an input device, a result of matching, by the buyer, a content of the invoice data with a content of a paper invoice sent from the supplier, when the result received through the input device shows that there is no difference between the content of the invoice data and the content of the paper invoice, generating accounts payable information based on the invoice data and transmitting the accounts payable information to the computer, and, when the result received through the input device shows that there is a difference between the content of the invoice data and the content of the paper invoice, transmitting the difference information to the computer, and the computer executes processing of receiving the difference information from the terminal of the buyer, storing the difference information in the storage device, and transmitting a confirmation request regarding the difference to the terminal of the supplier.

In the settlement operations support method according to this embodiment, the computer executes processing of, upon receipt of a payment request from the terminal of the buyer, reading post-aggregation payment schedule data on the buyer from the storage device and transmitting a settlement request corresponding to the content of the post-aggregation payment schedule data to a system of a bank used by the buyer indicated by the post-aggregation payment schedule data, and along with the processing of transmitting the settlement request to the system of the bank used by the buyer, generating a payment advice regarding the invoice data for which the settlement request has been made and transmitting the payment advice to the terminal of the supplier.

In the settlement operations support method according to this embodiment, the terminal of the buyer executes processing of, as a response to the payment request transmitted to the computer, acquiring the post-aggregation payment schedule data from the computer and displaying the post-aggregation payment schedule data on an output device, receiving, through an input device, a result of determination on acceptability of the payment request by the buyer checking the content of the post-aggregation payment schedule data against the content of a paper invoice sent from the supplier, when the result received through the input device approves the payment request, transmitting the payment request to the computer, and, when the result received through the input device rejects the payment request, transmitting the rejection to a predetermined terminal without transmitting the payment request to the computer.

In the settlement operations support method according to this embodiment, the computer executes processing of receiving accounts payable information based on the invoice data from the terminal of the buyer and storing the accounts payable information in the storage device, and write-off processing along with the processing of transmitting the settlement request to the system of the bank used by the buyer, the write-off processing including specifying the accounts payable information corresponding to identification information in the invoice data included in the settlement request and writing off the accounts payable information.

In the settlement operations support method according to this embodiment, the computer executes processing of, upon generation of the payment advice or according to an instruction from the terminal of the supplier, generating credit schedule information to an account of the supplier at the bank used by the supplier from payment detail information to the supplier included in the settlement request or the payment advice, and storing the generated information in the storage device, receiving accounts receivable information based on the invoice data from the terminal of the supplier, and storing the accounts receivable information in the storage device, and specifying the accounts receivable information corresponding to identification information of the invoice data included in the credit schedule information by matching the credit schedule information and the accounts receivable information, and generating write-off schedule information of the accounts receivable.

In the settlement operations support method according to this embodiment, the computer executes processing of receiving notification of credit to the account of the supplier from the bank used by the supplier, matching a credit content indicated by the notification with write-off schedule information of the accounts receivable, specifying the write-off schedule information of the accounts receivable corresponding to the credit content, and determining overage or shortage of a credit amount for the specified accounts receivable, when there is no overage or shortage of the credit amount as a result of the determination, executing write-off processing of the specified accounts receivable, and, when there is overage or shortage of the credit amount as a result of the determination, transmitting information on an overage or shortage amount to the terminal of the supplier and the terminal of the buyer, and executing the write-off processing of the specified accounts receivable according to the overage or shortage amount. Moreover, in the settlement operations support method according to this embodiment, the computer executes processing of reading the post-aggregation payment schedule data from the storage device for a supplier and a buyer in each of one or more pairs, offsetting payment amounts between the supplier and buyer, and transmitting a settlement request corresponding to a content for remaining payables left after the offsetting in the post-aggregation payment schedule data to the system of the bank used by the supplier or the buyer, which is indicated by the payment schedule data including only the content for the remaining payables.

### REFERENCE SIGNS LIST

10 settlement operations support system
100 platform server (computer)
101, 201, 301 storage device
102, 202, 302 program
103, 203, 303 memory
104, 204, 304 arithmetic device
206, 306 input device
207, 307 output device
105, 205, 305 communication device
110, 210, 310 data
120 network
125 invoice data
126 payment schedule data
127 accounts receivable information
128, 131 general ledger
129 difference information
130 accounts payable information
132 post-aggregation payment schedule data
133 buyer account information
134 payment advice
135 credit schedule information
136 accounts receivable write-off schedule information
137 credit information
139, 140 credit overage and shortage information
200 supplier terminal
300 buyer terminal
400 banking system

1. A settlement operations support method comprising:
executing, by a computer configured to mediate e-commerce transactions between companies, processing of receiving invoice data addressed to a buyer from a terminal of a supplier in e-commerce, storing the received invoice data in a storage device, and, in response to an acquisition request from a terminal of the buyer, reading the invoice data from the storage device and transmitting the invoice data to the terminal of the buyer;
executing, by the terminal of the buyer, processing of sending the computer a request to acquire the invoice data addressed to the buyer, receiving the relevant invoice data from the computer, generating payment schedule data addressed to the supplier by attaching predetermined settlement information or settlement information specified by the buyer through an input device to the invoice data, and transmitting the generated payment schedule data to the computer; and
executing, by the computer, processing of specifying payment schedule data sharing a common predetermined item or predetermined item specified by the terminal of the buyer among the payment schedule data received from the terminal of the buyer, merging the payment schedule data by summing up payment amounts in the specified payment schedule data, and storing the merged payment schedule data as post-aggregation payment schedule data in the storage device.

2. The settlement operations support method according to claim 1, wherein the terminal of the buyer executes processing of
displaying invoice data received from the computer on an output device,
receiving, through an input device, a result of matching, by the buyer, a content of the invoice data with a content of a paper invoice sent from the supplier,
when the result received through the input device shows that there is no difference between the content of the invoice data and the content of the paper invoice, generating accounts payable information based on the invoice data and transmitting the accounts payable information to the computer, and
when the result received through the input device shows that there is a difference between the content of the invoice data and the content of the paper invoice, transmitting difference information on the difference to the computer,
wherein the computer executes processing of receiving the difference information from the terminal of the buyer, storing the difference information in the storage device, and transmitting a confirmation request regarding the difference to the terminal of the supplier.

3. The settlement operations support method according to claim 1, wherein the computer executes processing of
upon receipt of a payment request from the terminal of the buyer, reading the post-aggregation payment schedule data on the buyer from the storage device and transmitting a settlement request corresponding to the content of the post-aggregation payment schedule data to a system of a bank used by the buyer indicated by the post-aggregation payment schedule data, and,
along with the processing of transmitting the settlement request to the system of the bank used by the buyer, generating a payment advice regarding the invoice data for which the settlement request has been made and transmitting the payment advice to the terminal of the supplier.

4. The settlement operations support method according to claim 3, wherein the terminal of the buyer executes processing of
acquiring the post-aggregation payment schedule data from the computer as a response to the payment request transmitted to the computer, and displaying the post-aggregation payment schedule data on an output device,
receiving, through an input device, a result of determination on acceptability of the payment request by the buyer checking the content of the post-aggregation payment schedule data against the content of a paper invoice sent from the supplier,
when the result received through the input device approves the payment request, transmitting the payment request to the computer, and
when the result received through the input device rejects the payment request, transmitting the rejection to a predetermined terminal without transmitting the payment request to the computer.

5. The settlement operations support method according to claim 3, wherein the computer executes
processing of receiving accounts payable information based on the invoice data from the terminal of the buyer and storing the accounts payable information in the storage device, and
write-off processing along with the processing of transmitting the settlement request to the system of the bank used by the buyer, the write-off processing including specifying the accounts payable information corresponding to identification information in the invoice data included in the settlement request and writing off the accounts payable information.

6. The settlement operations support method according to claim 3, wherein the computer executes processing of
upon generation of the payment advice or according to an instruction from the terminal of the supplier, generating credit schedule information to an account of the supplier at the bank used by the supplier from payment detail information to the supplier included in the settlement request or the payment advice, and storing the generated information in the storage device,
receiving accounts receivable information based on the invoice data from the terminal of the supplier, and storing the accounts receivable information in the storage device, and
specifying the accounts receivable information corresponding to identification information of the invoice data included in the credit schedule information by matching the credit schedule information and the accounts receivable information, and generating write-off schedule information of the accounts receivable.

7. The settlement operations support method according to claim 6, wherein the computer executes
processing of receiving notification of credit to the account of the supplier from the bank used by the supplier, matching a credit content indicated by the notification with write-off schedule information of the accounts receivable, specifying the write-off schedule information of the accounts receivable corresponding to the credit content, and determining overage or shortage of a credit amount for the specified accounts receivable,
when there is no overage or shortage of the credit amount as a result of the determination, executing write-off processing of the specified accounts receivable, and
when there is overage or shortage of the credit amount as a result of the determination, transmitting information on an overage or shortage amount to the terminal of the supplier and the terminal of the buyer, and executing the write-off processing of the specified accounts receivable according to the overage or shortage amount.

8. The settlement operations support method according to claim 1, wherein the computer executes processing of
reading the post-aggregation payment schedule data from the storage device for a supplier and a buyer in each of one or more pairs, offsetting payment amounts between the supplier and buyer, and transmitting a settlement request corresponding to a content for remaining payables left after the offsetting in the post-aggregation payment schedule data to the system of the bank used by the supplier or the buyer, which is indicated by the payment schedule data including only the content for the remaining payables.

9. A settlement operations support system comprising:
a computer configured to mediate e-commerce transactions between companies, the computer including an arithmetic device configured to execute:
processing of receiving invoice data addressed to a buyer from a terminal of a supplier in e-commerce, storing the received invoice data in a storage device, and, in response to an acquisition request from a terminal of the buyer, reading the invoice data from the storage device and transmitting the invoice data to the terminal of the buyer;
processing of receiving payment schedule data addressed to the supplier, the payment schedule data being generated by the terminal of the buyer attaching predetermined settlement information or settlement information specified by the buyer through an input device to the invoice data; and
processing of specifying payment schedule data sharing a common predetermined item or predetermined item specified by the terminal of the buyer among the received payment schedule data, merging the payment schedule data by summing up payment amounts in the specified payment schedule data, and storing the merged payment schedule data as post-aggregation payment schedule data in the storage device;
the terminal of the buyer including an arithmetic device configured to execute processing of sending the computer a request to acquire invoice data addressed to the buyer, receiving the relevant invoice data from the computer, generating payment schedule data addressed to the supplier by attaching predetermined settlement information or settlement information specified by the buyer through an input device to the invoice data, and transmitting the generated payment schedule data to the computer; and
the terminal of the supplier including an arithmetic device configured to execute processing of transmitting the invoice data addressed to the buyer in e-commerce to the computer.
